(19) United States
(12) Patent Application Publication
(10) Pub. No.: US 2024/0184231 A1
(43) Pub. Date: Jun. 6, 2024

(54) RESIN FILM, ENDLESS BELT, AND IMAGE FORMING APPARATUS

(71) Applicant: FUJIFILM Business Innovation Corp., Tokyo (JP)

(72) Inventors: Hideaki OHARA, Kanagawa (JP); Kenji KAJIWARA, Kanagawa (JP)

(73) Assignee: FUJIFILM Business Innovation Corp., Tokyo (JP)

(21) Appl. No.: 18/508,262

(22) Filed: Nov. 14, 2023

(30) Foreign Application Priority Data
Nov. 21, 2022 (JP) 2022-186038
Oct. 10, 2023 (JP) 2023-175235

(51) Int. Cl. G03G 15/16; G03G 15/20

(52) U.S. Cl. CPC G03G 15/162; G03G 15/2057

(57) ABSTRACT

A resin film includes a resin layer containing at least one solvent selected from the group consisting of a urea-based solvent, an alkoxy group-containing amide-based solvent, and an ester group-containing amide-based solvent, in which a content of the solvent is more than 2,200 ppm and equal to or less than 10,000 ppm with respect to the entire resin layer.

### CROSS-REFERENCE TO RELATED APPLICATIONS

This application is based on and claims priority under 35 USC 119 from Japanese Patent Application No. 2022-186038 filed Nov. 21, 2022 and No. 2023-175235 filed Oct. 10, 2023.

### BACKGROUND

### (i) Technical Field

The present invention relates to a resin film, an endless belt, and an image forming apparatus.

### (ii) Related Art

JP2017-223837A proposes “an endless belt having a polyimide resin layer which contains at least one solvent selected from a solvent group A consisting of a urea-based solvent, an alkoxy group-containing amide-based solvent, and an ester group-containing amide-based solvent in a content of 50 ppm or more and 2,000 ppm or less”.

JP2019-045677A proposes “an endless belt having a polyimide resin layer which contains a polyimide resin containing two or more types of at least one component of a component derived from a tetracarboxylic acid dianhydride and a component derived from a diamine compound, and contains at least one solvent selected from a solvent group A consisting of a urea-based solvent, an alkoxy group-containing amide-based solvent, and an ester group-containing amide-based solvent in a content of 50 ppm or more and 2,000 ppm or less”.

JP2014-170048A proposes “an intermediate transfer belt which is provided on an image forming apparatus including an image carrier, a developing means developing a latent image formed on the image carrier with a toner, the intermediate transfer belt to which a toner image developed by the developing means is primarily transferred, and a transferring means secondarily transferring the toner image carried on the intermediate transfer belt to a recording medium, and is a polyimide resin or a polyamide imide resin, in which the polyimide resin or the polyamide imide resin contains only y-butyrolactone of 5 ppm or more and 5,000 ppm or less as a residual solvent”.

### SUMMARY

Aspects of non-limiting first embodiment of the present invention relate to a resin film having a resin layer containing at least one solvent selected from the group consisting of a urea-based solvent, an alkoxy group-containing amide-based solvent, and an ester group-containing amide-based solvent, in which even in a case where the resin film is repeatedly bent, the occurrence of cracking at a bent portion is suppressed as compared with a case where a content of the solvent is equal to or less than 2,200 ppm or more than 10,000 ppm with respect to the entire resin layer.

Aspects of non-limiting second embodiment of the present invention relate to a resin film having a resin layer containing at least one solvent selected from the group consisting of a urea-based solvent, an alkoxy group-containing amide-based solvent, and an ester group-containing amide-based solvent, in which even in a case where the resin film is repeatedly bent, the occurrence of cracking at a bent portion is suppressed as compared with a case where a tensile breaking strength is less than 270 N/mm².

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above advantages includes the following means.

According to an aspect of the present disclosure, there is provided a resin film having a resin layer containing at least one solvent selected from the group consisting of a urea-based solvent, an alkoxy group-containing amide-based solvent, and an ester group-containing amide-based solvent, in which a content of the solvent is more than 2,200 ppm and equal to or less than 10,000 ppm with respect to the entire resin layer.

### BRIEF DESCRIPTION OF THE DRAWINGS

Exemplary embodiment(s) of the present invention will be described in detail based on the following figures, wherein:

FIG. 1 is a schematic configuration diagram showing an example of an image forming apparatus according to the present exemplary embodiment;

FIG. 2 is a schematic configuration diagram showing another example of the image forming apparatus according to the present exemplary embodiment;

FIG. 3 is a schematic configuration diagram showing an example of a fixing device according to a first aspect;

FIG. 4 is a schematic configuration diagram showing an example of a fixing device according to a second aspect; and

FIG. 5 is a schematic perspective view showing an example of an endless belt unit according to the present exemplary embodiment.

### DETAILED DESCRIPTION

Hereinafter, exemplary embodiments that are examples of the present invention will be described. The following descriptions and examples merely illustrate the exemplary embodiments, and do not limit the scope of the invention.

In a numerical range described stepwise in the present specification, an upper limit value or a lower limit value described in one numerical range may be replaced with an upper limit value or a lower limit value of another numerical range described stepwise. Further, in a numerical range described in the present specification, an upper limit value or a lower limit value of the numerical range may be replaced with a value shown in examples.

Each component may include plural kinds of corresponding substances.

In a case where the amount of each component in a composition is mentioned and plural kinds of substances corresponding to each component are present in the composition, unless otherwise specified, the amount means a total amount of the plural kinds of substances present in the composition.

### Resin Film

A resin film according to a first exemplary embodiment has a resin layer containing at least one solvent selected from the group consisting of a urea-based solvent, an alkoxy group-containing amide-based solvent, and an ester group-containing amide-based solvent, and the content of the solvent is more than 2,200 ppm and equal to or less than 10,000 ppm with respect to the entire resin layer.

In the resin film according to the first exemplary embodiment, even in a case where the resin film is repeatedly bent, the occurrence of cracking at a bent portion is suppressed due to the above-described configuration. The reason is presumed as follows.

A resin film having a resin layer may be used in a bent state. In a case where the resin film is repeatedly deformed by bending at a bent portion, cracking may occur at the bent portion due to fatigue.

In the resin film according to the first exemplary embodiment, the content of the solvent is more than 2,200 ppm and equal to or less than 10,000 ppm with respect to the entire resin layer. In a case where the content of the solvent is more than 2,200 ppm with respect to the entire resin layer, the flexibility of the resin film increases, and thus even in a case where the resin film is repeatedly deformed by bending at a bent portion, cracking at the bent portion is suppressed.

In addition, in a case where the content of the solvent is 10,000 ppm or less with respect to the entire resin layer, the flexibility of the resin film does not excessively increase, and thus permanent deformation is suppressed.

Moreover, the resin layer contains at least one solvent selected from the group consisting of a urea-based solvent, an alkoxy group-containing amide-based solvent, and an ester group-containing amide-based solvent. Since these solvents have a functional group with high polarity, the solvents have a high boiling point and are less likely to volatilize. Therefore, the content of the solvent in the resin layer is unlikely to change with time. Therefore, the flexibility of the resin film is easily maintained, and thus even in a case where the resin film is repeatedly deformed by bending at a bent portion, cracking at the bent portion is suppressed.

Therefore, even in a case where the resin film according to the first exemplary embodiment is repeatedly bent, the occurrence of cracking at a bent portion is suppressed.

A resin film according to the second exemplary embodiment has a resin layer containing at least one solvent selected from the group consisting of a urea-based solvent, an alkoxy group-containing amide-based solvent, and an ester group-containing amide-based solvent, and has a tensile breaking strength of 270 N/mm² or more.

In the resin film according to the second exemplary embodiment, even in a case where the resin film is repeatedly bent, the occurrence of cracking at a bent portion is suppressed due to the above-described configuration. The reason is presumed as follows.

The resin film according to the second exemplary embodiment has a resin layer containing at least one solvent selected from the group consisting of a urea-based solvent, an alkoxy group-containing amide-based solvent, and an ester group-containing amide-based solvent. Since the solvent is contained, the flexibility of the resin film is improved. In addition, for the same reason as described above, the content of the solvent in the resin layer is less likely to change with time, and the flexibility of the resin film is easily maintained.

In addition, in a case where the tensile breaking strength of the resin film is equal to or more than 270 N/mm², the stress generated in actual use is sufficiently smaller than the elastic limit.

Therefore, even in a case where the resin film according to the second exemplary embodiment is repeatedly bent, the occurrence of cracking at a bent portion is suppressed.

Hereinafter, the resin film corresponding to any of the first and second exemplary embodiments will be described in detail. However, an example of the resin film according to the exemplary embodiment of the present invention may be a resin film corresponding to either the first exemplary embodiment or the second exemplary embodiment.

### Resin Layer

### Solvent

The resin layer contains at least one solvent selected from the group consisting of a urea-based solvent, an alkoxy group-containing amide-based solvent, and an ester group-containing amide-based solvent.

The content of the solvent is more than 2,200 ppm and equal to or less than 10,000 ppm with respect to the entire resin layer.

From the viewpoint of further suppressing the occurrence of cracking at a bent portion, the content of the solvent is, for example, preferably equal to or more than 2,500 ppm and equal to or less than 9,000 ppm, more preferably equal to or more than 4,000 ppm and equal to or less than 8,000 ppm, and even more preferably equal to or more than 6,000 ppm and equal to or less than 7,000 ppm with respect to the entire resin layer.

Regarding the solvent (residual solvent) contained in the resin layer configuring the resin film, a measurement sample can be collected from the resin layer of the resin film to be measured to perform the measurement by a gas chromatography mass spectrometer (GC-MS) or the like. Specifically, the analysis can be performed by a gas chromatography mass spectrometer (GCMS QP-2010 manufactured by Shimadzu Corporation) equipped with a drop type pyrolyzer (manufactured by Frontier Laboratories Ltd.: PY-2020D).

Regarding the solvent contained in the resin layer configuring the resin film, 0.40 mg of a measurement sample is accurately weighed from the resin layer, and measured at a pyrolysis temperature of 400° C.
Pyrolyzer: manufactured by Frontier Laboratories Ltd.: PY-2020D
Gas Chromatography Mass Spectrometer: GCMS QP-2010 manufactured by Shimadzu Corporation
Pyrolysis Temperature: 400° C.
Gas Chromatograph Introduction Temperature: 280° C.
Inject Method: split ratio 1:50
Column: manufactured by Frontier Laboratories Ltd.: Ultra ALLOY-5, 0.25 μm, 0.25 μm ID, 30 m
Gas Chromatograph Temperature Program: 40° C.=>20° C./min=>280° C.−10 minute holding
Mass Range: EI, m/z=29-600

### Urea-Based Solvent

The urea-based solvent is a solvent having a urea group (N—C(═O)—N). Specifically, the urea-based solvent may be, for example, a solvent having a structure represented by “*—N(Ra¹)-C(═O)—N(Ra²)-*”. Here, Ra¹ and Ra² each independently represent a hydrogen atom, an alkyl group, a phenyl group, or a phenylalkyl group. Both terminals * of the two N atoms represent bond sites with other atomic groups of the structure. The urea-based solvent may be, for example, a solvent having a ring structure in which both terminals * of two N atoms are linked via a linking group consisting of alkylene, —O—, —C(═O)—, or a combination thereof.

The alkyl group represented by Ra¹ and Ra² may be chain-like, branched, or cyclic, and may have a substituent. Specific examples of the alkyl group include an alkyl group having 1 or more and 6 or less (for example, preferably 1 or more and 4 or less) carbon atoms (for example, a methyl group, an ethyl group, an n-propyl group, an i-propyl group, and an n-butyl group).

Examples of the substituent of the alkyl group include an alkoxy group having 1 or more and 4 or less carbon atoms, a hydroxyl group, a ketone group, an ester group, and an alkyl carbonyloxy group.

Specific examples of the ketone group include a methylcarbonyl group (acetyl group), an ethylcarbonyl group, and an n-propylcarbonyl group. Specific examples of the ester group include a methoxycarbonyl group, an ethoxycarbonyl group, an n-propoxycarbonyl group, and an acetoxy group. Specific examples of the alkyl carbonyloxy group include a methyl carbonyloxy group (acetyloxy group), an ethyl carbonyloxy group, and an n-propyl carbonyloxy group.

The phenyl skeleton of the phenyl group and the phenylalkyl group represented by Ra¹ and Ra² may have a substituent. Examples of the substituent of the phenyl skeleton include the same substituents as the examples of the substituent of the alkyl group.

In a case where the urea-based solvent has the ring structure in which both terminals * of two N atoms are linked, the number of ring members thereof may be, for example, 5 or 6.

Examples of the urea-based solvent include 1,3-dimethylurea, 1,3-diethylurea, 1,3-diphenylurea, 1,3-dicyclohexylurea, tetramethylurea, tetraethylurea, 2-imidazolidinone, propyleneurea, 1,3-dimethyl-2-imidazolidinone, and N,N-dimethylpropyleneurea.

Among these, the urea-based solvent is, for example, preferably 1,3-dimethylurea, 1,3-diethylurea, tetramethylurea, tetraethylurea, 1,3-dimethyl-2-imidazolidinone, or N,N-dimethylpropyleneurea, and most preferably tetramethylurea, tetraethylurea, 1,3-dimethyl-2-imidazolidinone, or N,N-dimethylpropyleneurea from the viewpoint of further suppressing the occurrence of cracking at a bent portion.

### Alkoxy Group-Containing Amide-Based Solvent and Ester Group-Containing Amide-Based Solvent

The alkoxy group-containing amide-based solvent is a solvent having an alkoxy group and an amide group. Meanwhile, the ester group-containing amide-based solvent is a solvent having an ester group and an amide group. Examples of the alkoxy group and the ester group include the same groups as the examples of the alkoxy group and the examples of the ester group described as the “substituent of the alkyl group represented by Ra¹ and Ra²” in the description of the urea-based solvent. The alkoxy group-containing amide-based solvent may have an ester group, and the ester group-containing amide-based solvent may have an alkoxy group.

Hereinafter, both the alkoxy group-containing amide-based solvent and the ester group-containing amide-based solvent will be referred to as “alkoxy group- or ester group-containing amide-based solvent” for description.

The alkoxy group- or ester group-containing amide-based solvent is not particularly limited, and specific examples thereof include an amide-based solvent represented by General Formula (Am1) and an amide-based solvent represented by General Formula (Am2).

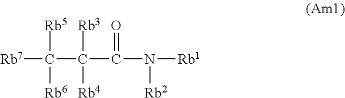

In General Formula (Am1), Rb¹, Rb², Rb³, Rb⁴, Rb⁵, and Rb⁶ each independently represent a hydrogen atom or an alkyl group. Rb⁷ represents an alkoxy group or an ester group.

The alkyl group represented by Rb¹ to Rb⁶ is synonymous with the “alkyl group represented by Ra¹ and Ra²” described in the description of the urea-based solvent.

The alkoxy group and the ester group represented by Rb⁷ is synonymous with the alkoxy group and the ester group described as the “substituent of the alkyl group represented by Ra¹ and Ra²” in the description of the urea-based solvent.

Hereinafter, specific examples of the amide-based solvent represented by General Formula (Am1) will be described, but are not limited thereto.

| Example | | | | | | | |
|---|---|---|---|---|---|---|---|
| Compound | | | | | | | |
| No. | Rb¹ | Rb² | Rb³ | Rb⁴ | Rb⁵ | Rb⁶ | Rb⁷ |
| B-1 | Me | Me | H | H | H | H | —CO₂Me |
| B-2 | Me | Me | H | H | H | H | —CO₂Et |
| B-3 | Et | Et | H | H | H | H | —CO₂Me |
| B-4 | Me | Me | H | H | H | H | —OMe |
| B-5 | Me | Me | H | H | H | H | —OEt |
| B-6 | Me | Me | H | H | H | H | -OnPr |
| B-7 | Me | Me | H | H | H | H | -OnBu |
| B-8 | Et | Et | H | H | H | H | —OMe |
| B-9 | Me | Me | H | H | H | H | —OC(═O)Me |
| B-10 | Me | Me | Me | H | H | H | —OMe |

In the specific examples of the amide-based solvent represented by General formula (Am1), Me is a methyl group, Et is an ethyl group, nPr is an n-propyl group, and nBu is an n-butyl group.

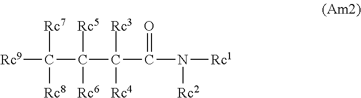

In General Formula (Am2), Rc¹, Rc², Rc³, Rc⁴, Rc⁵, Rc⁶, Rc⁷, and Rc⁸ each independently represent a hydrogen atom or an alkyl group. Rc⁹ represents an alkoxy group or an ester group.

The alkyl group represented by Rc¹ to Rc⁸ is synonymous with the “alkyl group represented by Ra¹ and Ra²” described in the description of the urea-based solvent.

The alkoxy group and the ester group represented by Rc⁹ is synonymous with the alkoxy group and the ester group described as the “substituent of the alkyl group represented by Ra¹ and Ra²” in the description of the urea-based solvent.

Hereinafter, specific examples of the amide-based solvent represented by General Formula (Am2) will be described, but are not limited thereto.

| Example | | | | | | | | | |
|---|---|---|---|---|---|---|---|---|---|
| Compound | | | | | | | | | |
| No. | Rc¹ | Rc² | Rc³ | Rc⁴ | Rc⁵ | Rc⁶ | Rc⁷ | Rc⁸ | Rc⁹ |
| C-1 | Me | Me | H | H | H | H | H | H | —CO₂Me |
| C-2 | Me | Me | Me | H | H | H | H | H | —CO₂Me |
| C-3 | Me | Me | H | H | H | H | Me | H | —CO₂Me |
| C-4 | Et | Et | H | H | H | H | H | H | —OMe |
| C-5 | Me | Me | H | H | Me | H | H | H | —CO₂Me |
| C-6 | Me | Me | H | H | H | H | H | H | —CO₂Et |
| C-7 | Me | Me | H | H | H | H | Me | H | —CO₂Et |
| C-8 | Me | Me | H | H | H | H | H | H | —OC(═O)Me |
| C-9 | Me | Me | H | H | H | H | H | H | —OEt |
| C-10 | Me | Me | H | H | H | H | H | H | -OnPr |

In the specific examples of the amide-based solvent represented by General formula (Am2), Me is a methyl group, Et is an ethyl group, and nPr is an n-propyl group.

Among these, the alkoxy group- or ester group-containing amide-based solvent is, for example, preferably 3-methoxy-N,N-dimethylpropanamide (Example Compound B-4), 3-n-butoxy-N,N-dimethylpropanamide (Example Compound B-7), or methyl 5-(dimethylamino)-2-methyl-5-oxopentanoate (Example Compound C-3), and more preferably 3-methoxy-N,N-dimethylpropanamide (Example Compound B-4) from the viewpoint of further suppressing the occurrence of cracking at a bent portion.

The solvent is, for example, preferably at least one selected from the group consisting of an alkoxy group-containing amide-based solvent and an ester group-containing amide-based solvent.

The alkoxy group-containing amide-based solvent and the ester group-containing amide-based solvent easily dissolve a material (for example, resin) configuring the resin layer in the manufacturing of the resin film. In addition, the solvent is difficult to volatilize due to a high boiling point thereof. Therefore, the content of the solvent in the resin layer is unlikely to change with time. Therefore, the flexibility of the resin film is easily maintained, and thus even in a case where the resin film is repeatedly deformed by bending at a bent portion, cracking at the bent portion is suppressed.

The alkoxy group-containing amide-based solvent is, for example, preferably at least one selected from the group consisting of 3-methoxy-N,N-dimethylpropanamide and 3-n-butoxy-N,N-dimethylpropanamide, and the ester group-containing amide-based solvent is, for example, preferably methyl 5-(dimethylamino)-2-methyl-5-oxopentanoate.

The solvent is, for example, particularly preferably 3-methoxy-N,N-dimethylpropanamide.

By using the alkoxy group-containing amide-based solvent and the ester group-containing amide-based solvent as the solvent, a material (for example, resin) configuring the resin layer in the manufacturing of the resin film is easily dissolved. In addition, the solvent is difficult to volatilize due to a high boiling point thereof. Therefore, the content of the solvent in the resin layer is unlikely to change with time. Therefore, the flexibility of the resin film is easily maintained, and thus even in a case where the resin film is repeatedly deformed by bending at a bent portion, cracking at the bent portion is suppressed.

The boiling point of the solvent is, for example, preferably equal to or higher than 200° C. and equal to or lower than 280° C., more preferably equal to or higher than 205° C. and equal to or lower than 275° C., and even more preferably equal to or higher than 210° C. and equal to or lower than 275° C.

Here, the boiling point of the solvent is a boiling point under atmospheric pressure (101 kPa).

In a case where the boiling point of the solvent is 200° C. or higher, the solvent is less likely to volatilize from the resin layer. Therefore, the content of the solvent in the resin layer is unlikely to change with time. Therefore, the flexibility of the resin film is easily maintained, and thus even in a case where the resin film is repeatedly deformed by bending at a bent portion, cracking at the bent portion is suppressed.

In addition, in a case where the boiling point of the solvent is 280° C. or lower, the amount of the residual solvent after a heating treatment at about 300° C. in a firing step in a method of manufacturing a resin film to be described later does not become excessive.

### Resin

The resin layer contains a resin. The resin is not particularly limited, and is preferably a polyimide resin from the viewpoint of suppressing the occurrence of cracking at a bent portion.

Examples of the polyimide resin include a polyimide obtained by imidizing a polyimide precursor to be described later.

The polyimide resin preferably has, for example, a structural unit derived from a tetracarboxylic acid dihydrate and a structural unit derived from a diamine compound.

In particular, the polyimide resin preferably has, for example, a structural unit derived from phenylenediamine and a structural unit derived from diaminodiphenyl ether as the structural unit derived from the diamine compound.

From the viewpoint of suppressing cracking at a bent portion, a content ratio of the structural unit derived from phenylenediamine to the structural unit derived from diaminodiphenyl ether (the structural unit derived from phenylenediamine/the structural unit derived from diaminodiphenyl ether) in the polyimide resin is, for example, in mole ratio, preferably equal to or more than 80/20 and equal to or less than 99.7/0.3, and more preferably equal to or more than 85/15 and equal to or less than 95/5.

The method for measuring the content ratio of the structural unit is as follows.

First, from several points of a mixed sample of phenylenediamine and diaminodiphenyl ether having a known mixing ratio, a peak intensity ratio of a peak at 1,515 cm⁻¹ (a peak derived from phenylenediamine) and a peak at 1,500 cm⁻¹ (a peak derived from diaminodiphenyl ether) is obtained by measurement with an infrared spectrophotometer (IR), and a calibration curve is drawn between the peak intensity ratio and the mixing ratio.

Next, the peak intensity ratio is obtained from a sample of the resin layer of the resin film to be measured by measurement with an infrared spectrophotometer (IR), and the mixing ratio is calculated from a calibration curve. The obtained mixing ratio is defined as the content ratio of the structural unit derived from phenylenediamine and the structural unit derived from diaminodiphenyl ether in the polyimide resin.

Here, a structural unit derived from a monomer forming the resin of the resin layer can be measured by, for example, analyzing and quantifying a component detected by pyrolysis gas chromatography mass spectrometry (GC-MS). Specifically, first, a measurement sample of the resin layer is prepared from a resin film to be measured. Next, the measurement sample is measured by a gas chromatography mass spectrometer (manufactured by Shimadzu Corporation: GCMS QP-2010) equipped with a drop type pyrolyzer (manufactured by Frontier Laboratories Ltd.: PY-2020D). In addition, the polyimide resin is decomposed into monomer units by a pyrolysis gas chromatography mass spectrometer, and the decomposition product obtained by decomposition is subjected to mass analysis to obtain the structure and ratio of the monomer.

### Conductive Particles

The resin layer configuring the resin film according to the present exemplary embodiment may optionally contain conductive particles added to impart conductivity. Examples of the conductive particles include conductive (for example, a volume resistivity of less than 10⁷ Ω·cm, the same shall apply hereinafter) or semiconductive (for example, a volume resistivity of 10⁷ Ω·cm or more and 10¹³ Ω·cm or less, the same shall apply hereinafter) particles, and the particles are selected according to the purpose of use.

Examples of the conductive particles include carbon black, metal (for example, aluminum, nickel, and the like), metal oxide (for example, yttrium oxide, tin oxide, and the like), and ion conductive substance (for example, potassium titanate, LiCl, and the like).

These conductive particles may be used alone or in combination of two or more kinds thereof. The primary particle diameter of the conductive particles may be, for example, less than 10 μm (for example, preferably 1 μm or less).

Among these, for example, carbon black may be used, and acidic carbon black having a pH of 5.0 or less may be particularly used as the conductive particles.

Examples of the acidic carbon black include carbon black whose surface is oxidized, such as carbon black obtained by imparting a carboxyl group, a quinone group, a lactone group, a hydroxyl group, or the like to the surface.

In a case where the acidic carbon black is applied to a transfer belt having a resin layer including a polyimide resin, the acidic carbon black is, for example, desirably carbon black having a pH of 4.5 or less, and more desirably acidic carbon black having a pH of 4.0 or less from the viewpoint of stability of electrical resistance with time and electric field dependence suppressing the electric field concentration due to transfer voltage.

The pH of the acidic carbon black is a value measured by a pH measuring method specified in JIS Z8802 (2011).

Specific examples of the carbon black include “Special Black 350”, “Special Black 100”, “Special Black 250”, “Special Black 5”, “Special Black 4”, “Special Black 4A”, “Special Black 550”, “Special Black 6”, “Color Black FW200”, “Color Black FW2”, and “Color Black FW2V” manufactured by ORION ENGINEERED CARBONS LLC., “MONARCH 1000” manufactured by Cabot Corporation, “MONARCH 1300”, “MONARCH 1400”, “MOGUL-L”, and “REGAL 400R” manufactured by Cabot Corporation.

The content of the conductive particles is not particularly limited. However, from the viewpoint of appearance, mechanical, and electrical quality of the resin film, the content of the conductive particles may be equal to or more than 1 part by mass and equal to or less than 40 parts by mass (for example, preferably equal to or more than 10 parts by mass and equal to or less than 30 parts by mass) with respect to 100 parts by mass of the resin of the resin layer.

### Other Additives

The resin layer configuring the resin film according to the present exemplary embodiment may contain various fillers and the like for the purpose of imparting various functions such as a mechanical strength. In addition, in a case where the resin layer includes a polyimide as a resin, a catalyst for promoting an imidization reaction, a leveling material for improving film forming quality, or the like may be contained.

Examples of the filler to be added to improve a mechanical strength include particulate materials such as a silica powder, an alumina powder, a barium sulfate powder, a titanium oxide powder, mica, and talc. In addition, in order to improve the water repellency and releasability of the surface of the resin layer, a fluororesin powder such as polytetrafluoroethylene (PTFE) or tetrafluoroethylene perfluoroalkyl vinyl ether copolymer (PFA) may be added.

As the catalyst for promoting the imidization reaction, a dehydrating agent such as an acid anhydride, an acid catalyst such as a phenol derivative, a sulfonic acid derivative, or a benzoic acid derivative, or the like may be used.

A surfactant may be added to improve the film forming quality of the resin layer. As the surfactant to be used, any of a cationic surfactant, an anionic surfactant, and a nonionic surfactant may be used.

The content of other additives may be selected according to target characteristics of the resin layer.

### Layer Structure

In the resin film according to the present exemplary embodiment, the resin layer may be used as the resin film as it is. In addition, the resin film consisting of a laminate having a functional layer such as a release layer on at least one of an inner peripheral surface or an outer peripheral surface of the resin layer may be provided.

### Physical Properties of Resin Film

In the resin film according to the present exemplary embodiment, a number of times of folding endurance according to a MIT test using a clamp having a radius of curvature R of 2 mm is, for example, preferably equal to or more than 300,000, more preferably equal to or more than 400,000, and even more preferably equal to or more than 500,000.

The number of times of folding endurance according to the MIT test represents the number of bends until the resin film breaks in a case where the resin film is repeatedly bent. Therefore, in a case where the number of times of folding endurance according to the MIT test is equal to or more than 300,000, a resin film is provided in which the occurrence of cracking at a bent portion is further suppressed even in a case where the resin film is repeatedly bent.

The number of times of folding endurance according to the MIT test is measured as follows.

The MIT test is based on JIS P 8115: 2001 (MIT tester method).

Specifically, a strip-like test piece having a length of 200 mm and a width of 15 mm in a peripheral direction is cut out from the resin film. Both ends of the strip-like test piece are fixed, and a tensile tension of 1 kgf is applied to repeatedly bend (fold) the test piece in a horizontal 90-degree direction with a clamp having a radius of curvature R of 2 mm as a fulcrum. At this time, the number until the strip-like test piece breaks is defined as the number of times of folding endurance.

The MIT test is performed under the environment of a temperature of 22° C. and a humidity of 55% RH.

The resin film according to the present exemplary embodiment has a tensile breaking strength of 270 N/mm² or more.

From the viewpoint of further suppressing the occurrence of cracking at a bent portion, the tensile breaking strength is, for example, preferably equal to or more than 320 N/mm² and equal to or less than 500 N/mm², more preferably equal to or more than 375 N/mm² and equal to or less than 475 N/mm², and even more preferably equal to or more than 400 N/mm² and equal to or less than 450 N/mm².

The tensile breaking strength is measured as follows.

A test piece is cut out into a strip-like shape having a width of 5 mm from the resin film, and installed on a tensile tester Model 1605N (manufactured by Aikoh Engineering Co., Ltd.) to measure a tensile breaking strength when the test piece is pulled at a constant speed of 10 mm/sec.

### Method of Manufacturing Resin Film

The resin film according to the present exemplary embodiment is, for example, preferably obtained by applying a coating liquid for forming a resin film to a coating object, and drying and firing the coating liquid.

Specific examples of the method of manufacturing the resin film include the following method.

A method of manufacturing a resin film includes, for example, a step of applying a polyimide precursor composition onto a cylindrical base material (mold) to form a coating film (coating film forming step), a step of drying the coating film formed on the base material to form a dried film (drying step), a step of imidizing (heating) the dried film to imidize the polyimide precursor to form a molded body of the polyimide resin (firing step), and a step of removing the molded body of the polyimide resin from the base material to obtain a resin film (removing step). The molded body of the polyimide resin is a resin layer. Specifically, for example, the method is as follows.

The polyimide precursor composition is as described in “Polyimide Precursor Composition” to be described later.

First, a polyimide precursor composition is applied to an inner surface or an outer surface of a cylindrical base material to form a coating film. A cylindrical metal base material is, for example, preferably used as the cylindrical base material. Instead of the metal, a base material made of another material such as a resin, glass, or ceramic may be used. In addition, a glass coating, a ceramic coating, or the like may be provided on the surface of the base material, or a silicone-based or fluorine-based release agent may be applied.

The shape of the base material is not limited to a cylindrical shape, and a shape such as a plate shape may be selected depending on the use of the resin film.

Here, in order to apply the polyimide precursor composition with high accuracy, for example, a step of defoaming the polyimide precursor composition may be performed before coating. In a case where the polyimide precursor composition is defoamed, foaming during coating and the occurrence of defects in the coating film are suppressed.

Examples of the method of defoaming the polyimide precursor composition include a method of making a decompressed state and a method of performing centrifugation. The method of making a decompressed state is, for example, preferably performed since this method is simple in defoaming in a decompressed state and has large defoaming performance.

Next, the cylindrical base material on which the coating film of the polyimide precursor composition is formed is put in a heating or vacuum environment, and the coating film is dried to form a dried film. 30% by mass or more, and for example, preferably 50% by mass or more of the solvent contained is volatilized.

Next, the dried film is imidized (heated). Accordingly, a molded body of the polyimide resin is formed.

As heating conditions for imidization, the dried film is heated at, for example, 150° C. or higher and 400° C. or lower (for example, preferably 200° C. or higher and 300° C. or lower) for 20 minutes or longer and 60 minutes or shorter to generate an imidization reaction, and thus a molded body of the polyimide resin is formed. In a heating reaction, for example, heating may be performed by raising a temperature step by step, or gradually raising a temperature at a certain speed before the temperature reaches a final temperature for the heating. The imidization temperature varies depending on, for example, the kinds of tetracarboxylic acid dianhydride and diamine used as raw materials. Since insufficient imidization results in poor mechanical and electrical characteristics, the temperature is set to complete the imidization.

After that, the molded body of the polyimide resin is removed from the cylindrical base material to obtain a resin film.

In a case where a resin film having a functional layer such as a release layer in addition to the resin layer is obtained, the resin film is obtained by appropriately forming a functional layer on the molded body of the polyimide resin.

### Polyimide Precursor Composition

The polyimide precursor composition is a polyimide precursor composition containing a resin having a repeating unit represented by General Formula (I) (hereinafter, referred to as “polyimide precursor”) and at least one solvent selected from the group consisting of a urea-based solvent, an alkoxy group-containing amide-based solvent, and an ester group-containing amide-based solvent.

In addition, the polyimide precursor composition contains a polyimide precursor containing two or more kinds of at least one of a structural unit derived from a tetracarboxylic acid dianhydride or a structural unit derived from a diamine compound. The polyimide precursor may be a copolymer having a repeating unit represented by General Formula (I), or a mixture of different kinds of homopolymers having a repeating unit represented by General Formula (I).

The polyimide precursor composition may optionally contain conductive particles and other additives.

### Polyimide Precursor

Examples of the polyimide precursor include a resin having a repeating unit represented by General Formula (I) (polyamic acid).

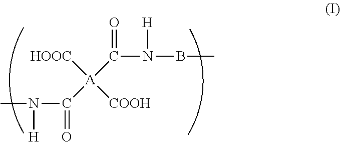

In General Formula (I), A represents a tetravalent organic group, and B represents a divalent organic group.

Here, in General Formula (I), examples of the tetravalent organic group represented by A include a residue obtained by removing four carboxyl groups from the tetracarboxylic acid dianhydride used as a raw material.

Meanwhile, examples of the divalent organic group represented by B include a residue obtained by removing two amino groups from the diamine compound used as a raw material.

That is, the polyimide precursor having a repeating unit represented by General Formula (I) is a polymer of a tetracarboxylic acid dianhydride and a diamine compound. That is, the polyimide precursor contains a component derived from a tetracarboxylic acid dianhydride and a component derived from a diamine compound.

Examples of the tetracarboxylic acid dianhydride include both an aromatic compound and an aliphatic compound, and for example, the aromatic compound may be used. That is, in General Formula (I), the tetravalent organic group represented by A may be, for example, an aromatic organic group.

Examples of the aromatic tetracarboxylic acid dianhydride include pyromellitic acid dianhydride, 3,3′,4,4′-benzophenone tetracarboxylic acid dianhydride, 3,3′,4,4′-biphenyl sulfone tetracarboxylic acid dianhydride, 1,4,5,8-naphthalene tetracarboxylic acid dianhydride, 2,3,6,7-naphthalene tetracarboxylic acid dianhydride, 3,3′,4,4′-biphenyl ether tetracarboxylic acid dianhydride, 3,3′,4,4′-dimethyldiphenylsilane tetracarboxylic acid dianhydride, 3,3′,4,4′-tetraphenylsilane tetracarboxylic acid dianhydride, 1,2,3,4-furantetracarboxylic acid dianhydride, 4,4′-bis(3,4-dicarboxyphenoxy) diphenylsulfide dianhydride, 4,4′-bis(3,4-dicarboxyphenoxy) diphenylsulfone dianhydride, 4,4′-bis (3,4-dicarboxyphenoxy) diphenylpropane dianhydride, 3,3′,4,4′-perfluoroisopropylidene diphthalic acid dianhydride, 3,3′,4,4′-biphenyl tetracarboxylic acid dianhydride, 2,3,3′,4′-biphenyl tetracarboxylic acid dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenyl methane dianhydride, and 4,4′-oxydiphthalic acid dianhydride (ODPA).

Examples of the aliphatic tetracarboxylic acid dianhydride include an aliphatic or alicyclic tetracarboxylic acid dianhydride such as butanetetracarboxylic acid dianhydride, 1,2,3,4-cyclobutanetetracarboxylic acid dianhydride, 1,3-dimethyl-1,2,3,4-dyclobutanetetracarboxylic acid dianhydride, 1,2,3,4-cyclopentanetetracarboxylic acid dianhydride, 2,3,5-tricarboxycyclopentylacetic acid dianhydride, 3,5,6-tricarboxynorbonane-2-acetic acid dianhydride, 2,3,4,5-tetrahydrofuran tetracarboxylic acid dianhydride, 5-(2,5-dioxotetrahydrofuryl)-3-methyl-3-cyclohexene-1,2-dicarboxylic acid dianhydride, and bicyclo[2,2,2]-oct-7-ene-2,3,5,6-tetracarboxylic acid dianhydride; and an aliphatic tetracarboxylic acid dianhydride having an aromatic ring such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among these, as the tetracarboxylic acid dianhydride, for example, the aromatic tetracarboxylic acid dianhydride may be used. Specifically, for example, the pyromellitic acid dianhydride, the 3,3′,4,4′-biphenyl tetracarboxylic acid dianhydride, the 2,3,3′,4′-biphenyl tetracarboxylic acid dianhydride, the 3,3′,4,4′-biphenyl ether tetracarboxylic acid dianhydride, the 3,3′,4,4′-benzophenone tetracarboxylic acid dianhydride, and the 4,4′-oxydiphthalic acid dianhydride may be used. Further, for example, the pyromellitic acid dianhydride, the 3,3′,4,4′-biphenyl tetracarboxylic acid dianhydride, the 3,3′,4,4′-benzophenone tetracarboxylic acid dianhydride, and the 4,4′-oxydiphthalic acid dianhydride may be used. In particular, for example, the 3,3′,4,4′-biphenyl tetracarboxylic acid dianhydride may be used.

The tetracarboxylic acid dianhydride may be used alone or two or more kinds thereof may be used in combination.

In addition, in a case where two or more kinds are used in combination, each of the aromatic tetracarboxylic acid dianhydrides and the aliphatic tetracarboxylic acid dianhydrides may be used in combination, or the aromatic tetracarboxylic acid dianhydride and the aliphatic tetracarboxylic acid dianhydride may be combined.

In a case where the polyimide precursor contains two or more kinds of structural units derived from a tetracarboxylic acid dianhydride, the aspect of the structural unit derived from a tetracarboxylic acid dianhydride is not particularly limited. For example, the structural unit derived from a tetracarboxylic acid dianhydride may be contained as a copolymer using two or more kinds of tetracarboxylic acid dianhydrides or a mixture of copolymers. In addition, the structural unit derived from a tetracarboxylic acid dianhydride may be contained as a mixture of a homopolymer using one kind of tetracarboxylic acid dianhydride and a homopolymer or copolymer using a different tetracarboxylic acid dianhydride.

In a case where the polyimide precursor contains two or more kinds of structural units derived from a tetracarboxylic acid dianhydride, the component derived from the tetracarboxylic acid dianhydride may include, for example, a structural unit derived from 3,3′,4,4′-biphenyl tetracarboxylic acid dianhydride from the viewpoint of suppressing the occurrence of cracks when meandering is caused.

In particular, in a case where the polyimide precursor contains a structural unit derived from 3,3′,4,4′-biphenyl tetracarboxylic acid dianhydride, for example, the content ratio of the structural unit derived from 3,3′,4,4′-biphenyl tetracarboxylic acid dianhydride with respect to the entire structural units derived from the tetracarboxylic acid dianhydride may be equal to or more than 70% by mass and equal to or less than 99% by mass (for example, preferably equal to or more than 80% by mass and equal to or less than 95% by mass).

Meanwhile, the diamine compound is a diamine compound having two amino groups in the molecular structure. Examples of the diamine compound include both an aromatic compound and an aliphatic compound, and the aromatic compound may be used. That is, in General Formula (I), the divalent organic group represented by B may be, for example, an aromatic organic group.

Examples of the diamine compound include an aromatic diamine such as p-phenylenediamine, m-phenylenediamine, 4,4′ -diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; an aromatic diamine, having two amino groups bonded to an aromatic ring and a hetero atom other than a nitrogen atom of the amino groups, such as diaminotetraphenylthiophene; and an aliphatic diamine and an alicyclic diamine such as 1,1-m-xylylenediamine, 1,3-propane diamine, tetramethylenediamine, pentamethylenediamine, octamethylenediamine, nonamethylenediamine, 4,4-diaminoheptamethylenediamine, 1,4-diaminocyclohexane, isophorone diamine, tetrahydrodicyclopentadienylenediamine, hexahydro-4,7-methanoin danylene dimethylenediamine, tricyclo[6,2,1,0^{2,7}]-undecylene dimethyldiamine, and 4,4′-methylene bis(cyclohexylamine).

Among these, as the diamine compound, for example, the aromatic diamine compound may be used. Specifically, for example, the p-phenylenediamine, the m-phenylenediamine, the 4,4′-diaminodiphenylmethane, the 4,4′-diaminodiphenyl ether, the 3,4′-diaminodiphenyl ether, the 4,4′-diaminodiphenyl sulfide, and the 4,4′-diaminodiphenyl sulfone may be used. In particular, for example, the p-phenylenediamine and 4,4′-diaminodiphenyl ether may be used.

The diamine compound may be used alone or two or more kinds thereof may be used in combination. From the viewpoint of suppressing the occurrence of breakage when meandering is caused, two or more kinds of diamine compounds are, for example, preferably used. In addition, in a case where two or more kinds are used in combination, each of the aromatic diamine compounds and the aliphatic diamine compounds may be used in combination, or the aromatic diamine compound and the aliphatic diamine compound may be combined.

In a case where the polyimide precursor contains two or more kinds of structural units derived from a diamine compound, the aspect of the structural unit derived from a diamine compound is not particularly limited. For example, the structural unit derived from a diamine compound may be contained as a copolymer using two or more kinds of diamine compounds or a mixture of copolymers. In addition, the structural unit derived from a diamine compound may be contained as a mixture of a homopolymer using one kind of diamine compound and a homopolymer or copolymer using a different diamine compound.

In a case where the polyimide precursor contains two or more kinds of structural units derived from diamine compounds, for example, at least a structural unit derived from p-phenylenediamine or a structural unit derived from diaminodiphenyl ether (such as 4,4′-diaminodiphenyl ether) may be contained from the viewpoint of suppressing the occurrence of cracking at a bent portion. From the same viewpoint, both the structural unit derived from p-phenylenediamine and the structural unit derived from diaminodiphenyl ether may be contained. Among these, at least the structural unit derived from p-phenylenediamine is, for example, preferably contained.

In particular, in a case where the polyimide precursor contains a structural unit derived from p-phenylenediamine, for example, the content ratio of the structural unit derived from p-phenylenediamine with respect to the entire structural units derived from the diamine compound may be equal to or more than 70% by mass and equal to or less than 90% by mass (for example, preferably equal to or more than 75% by mass and equal to or less than 85% by mass).

A combination in a case where two or more kinds of structural units derived from diamine compounds are contained is, as described above, for example, preferably a combination of a structural unit derived from p-phenylenediamine and a structural unit derived from diaminodiphenyl ether (such as 4,4′-diaminodiphenyl ether).

From the viewpoint of suppressing the occurrence of cracking at a bent portion, the content ratio of the structural unit derived from p-phenylenediamine to the structural unit derived from diaminodiphenyl ether is, for example, preferably equal to or more than 70/30 and equal to or less than 90/10 in mass ratio.

From the same viewpoint, a content ratio of the structural unit derived from phenylenediamine to the structural unit derived from diaminodiphenyl ether (the structural unit derived from phenylenediamine/the structural unit derived from diaminodiphenyl ether) is, for example, in mole ratio, preferably equal to or more than 80/20 and equal to or less than 99.7/0.3, and more preferably equal to or more than 85/15 and equal to or less than 95/5.

The polyimide precursor may be a resin imidized partially.

Specific examples of the polyimide precursor include resins having repeating units represented by General Formula (I-1), General Formula (I-2), and General Formula (I-3).

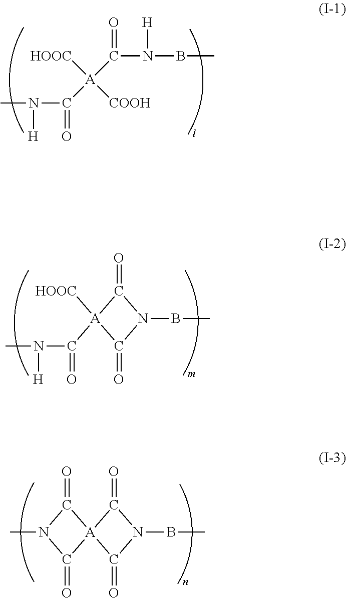

In General Formula (I-1), General Formula (I-2), and General Formula (I-3), A represents a tetravalent organic group, and B represents a divalent organic group. A and B are synonymous with A and B in General Formula (I).

1 represents an integer of 1 or more, and m and n each independently represent 0 or an integer of 1 or more.

Here, in the bonds of the polyimide precursor (reaction portions of tetracarboxylic acid dianhydride and diamine compound), a proportion of the number of imide-ring closure bonds (2n+m) to the total number of bonds (2l+2m+2n), that is, the imidization rate of the polyimide precursor is represented by “(2n+m)/(2l+2m+2n)”. This value is, for example, preferably 0.2 or less, more preferably 0.15 or less, and most preferably 0.1 or less.

By adjusting the imidization rate in the above range, the occurrence of gelation or precipitation and separation of the polyimide precursor is suppressed.

The imidization rate (value of “(2n+m)/(2l+2m+2n)”) of the polyimide precursor is measured by the following method.

### Measurement of Imidization Rate of Polyimide Precursor

### Preparation of Polyimide Precursor Sample

(i) A polyimide precursor composition to be measured is applied onto a silicon wafer in a range of a film thickness of 1 μm or more and 10 μm or less to prepare a coating film sample.
(ii) The coating film sample is dipped in tetrahydrofuran (THF) for 20 minutes to replace the solvent in the coating film sample with tetrahydrofuran (THF). The solvent to which the sample is dipped is not limited to THF, and can be selected from solvents that do not dissolve the polyimide precursor and can be mixed with a solvent component contained in the polyimide precursor composition. Specifically, alcohol solvents such as methanol and ethanol, and ether compounds such as dioxane are used.
(iii) The coating film sample is taken out from the THF, and a N₂ gas is blown to the THE adhered to the surface of the coating film sample to remove the THF. Under a reduced pressure of 10 mmHg or less, the coating film sample is treated in a range of 5° C. or higher and 25° C. or lower for 12 hours or longer, and dried to prepare a polyimide precursor sample.

### Preparation of 100%-Imidized Standard Sample

(iv) In the same manner as in (i), a polyimide precursor composition to be measured is applied onto a silicon wafer to prepare a coating film sample.
(v) The coating film sample is heated at 380° C. for 60 minutes to cause an imidization reaction, and a 100%-imidized standard sample is thus prepared.

### Measurement and Analysis

(vi) Using a Fourier transform infrared spectrophotometer (FT-730 manufactured by Horiba Ltd.), the infrared absorption spectra of the 100%-imidized standard sample and the polyimide precursor sample are measured. A ratio I′(100) of an absorption peak derived from the imide bond in the vicinity of 1,780 cm⁻¹ (Ab′(1,780 cm⁻¹)) to an absorption peak derived from the aromatic ring in the vicinity of 1,500 cm⁻¹ (Ab′(1,500 cm⁻¹)) of the 100%-imidized standard sample is obtained.
(vii) Similarly, the polyimide precursor sample is measured, and a ratio I(x) of an absorption peak derived from the imide bond in the vicinity of 1,780 cm⁻¹ (Ab(1,780 cm⁻¹)) to the absorption peak derived from the aromatic ring in the vicinity of 1,500 cm⁻¹ (Ab(1,500 cm⁻¹)) is obtained.

Then, the measured absorption peaks I′(100) and I(x) are used to calculate the imidization rate of the polyimide precursor based on the following Formulae.

imidization rate of polyimide precursor=I(x)/I′(100) Formula

I′(100)=(Ab′(1,780 cm⁻¹))/(Ab′(1,500 cm⁻¹)) Formula

I(x)=(Ab(1,780 cm⁻¹))/(Ab(1,500 cm⁻¹)) Formula

The measurement of the imidization rate of the polyimide precursor is applied to the measurement of the imidization rate of the aromatic polyimide precursor. In a case where the imidization rate of the aliphatic polyimide precursor is measured, a peak derived from a structure which does not change before and after an imidization reaction is used as an internal standard peak, instead of an absorption peak derived from an aromatic ring.

### Terminal Amino Group of Polyimide Precursor

The polyimide precursor may include, for example, a polyimide precursor (resin) having an amino group at a terminal, and is preferably a polyimide precursor having an amino group at all terminals.

The amino group is included at a molecular terminal of the polyimide precursor by, for example, adding a molar equivalent of the diamine compound used for polymerization reaction, more than a molar equivalent of the tetracarboxylic acid dianhydride. The ratio of the molar equivalents of the tetracarboxylic acid dianhydride and the diamine compound is, for example, preferably in a range of 0.92 or more and 0.9999 or less, and more preferably in a range of 0.93 or more and 0.999 or less in a case where the molar equivalent of the diamine compound is 1.

In a case where the ratio of the molar equivalents of the diamine compound and the tetracarboxylic acid dianhydride is equal to or more than 0.9, the effect of the amino group at the molecular terminal is large, and good dispersibility can be easily obtained. In addition, in a case where the ratio of the molar equivalents is equal to or less than 0.9999, the molecular weight of the polyimide precursor to be obtained is large, and for example, a sufficient film strength (tearing strength and tensile strength) can be easily obtained when a molded body of the polyimide resin is formed.

The terminal amino group of the polyimide precursor is detected by allowing a trifluoroacetic acid anhydride (quantitatively reacting with the amino group) to act on the polyimide precursor composition. That is, the terminal amino group of the polyimide precursor is trifluoroacetylated with the trifluoroacetic acid anhydride. After the treatment, the polyimide precursor is purified by reprecipitation or the like to remove excessive trifluoroacetic acid anhydride and trifluoroacetic acid residue. The amount of fluorine atoms introduced in the polyimide precursor after the treatment is quantified by nuclear magnetic resonance (¹⁹F-NMR), and thus the amount of the terminal amino group of the polyimide precursor is measured.

The number average molecular weight of the polyimide precursor may be, for example, equal to or more than 5,000 and equal to or less than 100,000, for example, more preferably equal to or more than 7,000 and equal to or less than 50,000, and even more preferably equal to or more than 10,000 and equal to or less than 30,000.

In a case where the number average molecular weight of the polyimide precursor is in the above range, the solubility of the polyimide precursor in the composition and the mechanical characteristics of the film after film formation are improved.

By adjusting the ratio of the molar equivalents of the tetracarboxylic acid dianhydride and the diamine compound, a polyimide precursor having a target number average molecular weight can be obtained.

The number average molecular weight of the polyimide precursor is measured by a gel permeation chromatography (GPC) method under the following measurement conditions.
Column: Tosoh TSK gel α-M (7.8 mm I.D×30 cm)
Eluent: DMF (dimethylformamide)/30 mM LiBr/60 mM phosphoric acid
Flow velocity: 0.6 mL/min
Injection amount: 60 μL
Detector: RI (differential refractive index detector)

The content (concentration) of the polyimide precursor may be, for example, equal to or more than 0.1% by mass and equal to or less than 40% by mass, for example, preferably equal to or more than 0.5% by mass and equal to or less than 25% by mass, and more preferably equal to or more than 1% by mass and equal to or less than 20% by mass with respect to the entire polyimide precursor composition.

### Method of Manufacturing Polyimide Precursor Composition

The method of manufacturing the polyimide precursor composition is not particularly limited. Examples thereof include a method in which, in a solvent containing at least one solvent selected from the group consisting of a urea-based solvent, an alkoxy group-containing amide-based solvent, and an ester group-containing amide-based solvent, the tetracarboxylic acid dianhydride and the diamine compound described above are polymerized to obtain a polyimide precursor.

The reaction temperature during the polymerization reaction of the polyimide precursor may be, for example, equal to or higher than 0° C. and equal to or lower than 70° C., for example, preferably equal to or higher than 10° C. and equal to or lower than 60° C., and more preferably equal to or higher than 20° C. and equal to or lower than 55° C. By setting the reaction temperature to 0° C. or higher, the progress of the polymerization reaction is promoted, the time necessary for the reaction is shortened, and the productivity is easily improved. Meanwhile, in a case where the reaction temperature is equal to or lower than 70° C., the progress of the imidization reaction occurring in the molecule of the polyimide precursor formed is suppressed, and the precipitation or gelation accompanied with a reduction in solubility of the polyimide precursor is easily suppressed.

In addition, the time during the polymerization reaction of the polyimide precursor may be, for example, in a range of 1 hour or longer and 24 hours or shorter according to the reaction temperature.

### Example of Use of Resin Film

The resin film according to the present exemplary embodiment can be used as an endless belt.

Further, the resin film according to the present exemplary embodiment can be used, for example, as a functional layer of a component called a Dynamic Flex in a Flexible Print Circuit (FPC) that is repeatedly bent during the life cycle of a product. Examples of the Dynamic Flex include a hard disk drive, an optical pickup, a hinge of a mobile phone, and the like.

In addition, the resin film according to the exemplary embodiment can be used as an electric insulating material, a pipe covering material, an electromagnetic wave insulating material, a heat source insulator, and an electromagnetic wave absorbing film.

### Endless Belt

The endless belt according to the present exemplary embodiment consists of the resin film according to the present exemplary embodiment. That is, an endless belt according to the present exemplary embodiment has a resin layer containing at least one solvent selected from the group consisting of a urea-based solvent, an alkoxy group-containing amide-based solvent, and an ester group-containing amide-based solvent, and the content of the solvent is more than 2,200 ppm and equal to or less than 10,000 ppm with respect to the entire resin layer.

The endless belt according to the present exemplary embodiment can be used as, for example, an endless belt for an electrophotographic image forming apparatus. Examples of the endless belt for an electrophotographic image forming apparatus include an intermediate transfer belt, a transfer belt (recording medium transport belt), a fixing belt (heating belt, pressure belt), and a transport belt (recording medium transport belt). The endless belt according to the present exemplary embodiment can also be used as, for example, a belt-like member such as a transport belt, a drive belt, a laminated belt, an electric insulating material, a pipe covering material, an electromagnetic wave insulating material, a heat source insulator, and an electromagnetic wave absorbing film, other than the endless belt for an image forming apparatus.

### Image Forming Apparatus

An image forming apparatus according to the present exemplary embodiment has the above-described endless belt. In a case where the endless belt is applied to a belt such as an intermediate transfer belt, a transfer belt, or a transport belt (recording medium transport belt), examples of the image forming apparatus according to the present exemplary embodiment include the following image forming apparatus including:
an image holder; a charging device that charges a surface of the image holder; an electrostatic charge image forming device that forms an electrostatic charge image on the charged surface of the image holder; a developing device that develops the electrostatic charge image formed on the surface of the image holder with a developer containing a toner to form a toner image; and a transfer device that transfers the toner image to a surface of a recording medium via the endless belt according to the present exemplary embodiment.

The transfer device may have an endless belt unit to be described later.

In the image forming apparatus according to the present exemplary embodiment, at least one selected from the group consisting of the transfer device and a fixing device preferably has, for example, the endless belt according to the present exemplary embodiment.

In a case where the fixing device has the endless belt according to the present exemplary embodiment, examples of the configuration of the image forming apparatus according to the present exemplary embodiment include a configuration in which the transfer device includes an intermediate transfer body, a primary transfer device primarily transferring a toner image formed on the image holder to the intermediate transfer body, and a secondary transfer device secondarily transferring the toner image transferred to the intermediate transfer body to a recording medium, and the endless belt according to the present exemplary embodiment is provided as the intermediate transfer body.

In a case where the fixing device has the endless belt according to the present exemplary embodiment, the image forming apparatus according to the present exemplary embodiment is, for example, preferably applied to a belt such as a fixing belt (heating belt, pressure belt). Specific examples of the image forming apparatus include the following image forming apparatus having a configuration including:
an image holder; a charging device that charges a surface of the image holder; an electrostatic charge image forming device that forms an electrostatic charge image on the charged surface of the image holder; a developing device that develops the electrostatic charge image formed on the surface of the image holder with a developer containing a toner to form a toner image; a transfer device that transfers the toner image to a recording medium; and a fixing device that fixes the toner image to the recording medium. In addition, as the fixing device, a fixing device including a first rotating body and a second rotating body disposed in contact with an outer surface of the first rotating body, in which at least one of the first rotating body or the second rotating body is the endless belt according to the present exemplary embodiment is applied.

In addition, the image forming apparatus according to the present exemplary embodiment may have, for example, a configuration in which the transfer device includes a recording medium transport body for transporting a recording medium (recording medium transport belt) and a transfer device for transferring a toner image formed on an image holder to a recording medium transported by the recording medium transport body, and the endless belt according to the present exemplary embodiment is provided as the recording medium transport body.

Examples of the image forming apparatus according to the present exemplary embodiment include a normal monochrome image forming apparatus which accommodates only a monochromatic toner in a developing device, a color image forming apparatus which sequentially repeats primary transfer of a toner image held on an image holder to an intermediate transfer body, and a tandem color image forming apparatus in which a plurality of image holders including developing units of respective colors are disposed in series on an intermediate transfer body.

Hereinafter, the image forming apparatus according to the present exemplary embodiment will be described with reference to the drawings.

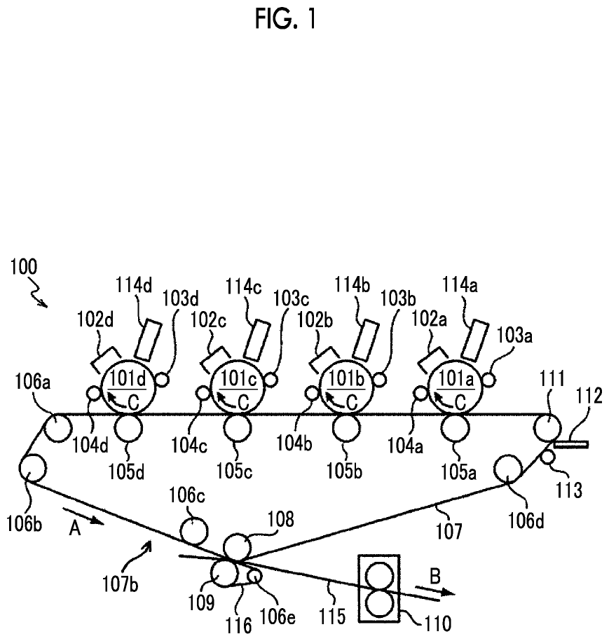

FIG. 1 is a schematic configuration diagram showing an example of the image forming apparatus according to the present exemplary embodiment. The image forming apparatus shown in FIG. 1 is an image forming apparatus in which the endless belt according to the present exemplary embodiment is applied to an intermediate transfer body (intermediate transfer belt).

As shown in FIG. 1, an image forming apparatus 100 according to the present exemplary embodiment is, for example, a so-called tandem type, in which around 4 image holders 101a to 101d each formed of an electrophotographic photoreceptor, charging devices 102a to 102d, exposure devices 114a to 114d, developing devices 103a to 103d, primary transfer devices (primary transfer rolls) 105a to 105d, and image holder cleaning devices 104a to 104d are sequentially disposed along a rotation direction of the image holder. A static eliminator may be provided for removing the residual potential remaining on surfaces of the image holders 101a to 101d after transfer.

An intermediate transfer belt 107 is supported while being applied with a tension by support rolls 106a to 106d, a drive roll 111, and a counter roll 108, and forms an endless belt unit 107b. By the support rolls 106a to 106d, the drive roll 111, and the counter roll 108, the intermediate transfer belt 107 can move the image holders 101a to 101d and the primary transfer rolls 105a to 105d in the direction of the arrow A while being in contact with the surfaces of the image holders 101a to 101d. The sites where the primary transfer rolls 105a to 105d are in contact with the image holders 101a to 101d via the intermediate transfer belt 107 are primary transfer portions, and a primary transfer voltage is applied to the contact portions between the image holders 101a to 101d and the primary transfer rolls 105a to 105d.

As a secondary transfer device, the counter roll 108 and a secondary transfer roll 109 are disposed to be opposed to each other via the intermediate transfer belt 107 and a secondary transfer belt 116. The secondary transfer belt 116 is supported by the secondary transfer roll 109 and a support roll 106e. A recording medium 115 such as paper is moved in a region sandwiched between the intermediate transfer belt 107 and the secondary transfer roll 109 in the direction of arrow B while being in contact with the surface of the intermediate transfer belt 107. Then, the recording medium passes through a fixing device 110. The site where the secondary transfer roll 109 is in contact with the counter roll 108 via the intermediate transfer belt 107 and the secondary transfer belt 116 is a secondary transfer portion, and a secondary transfer voltage is applied to the contact portion between the secondary transfer roll 109 and the counter roll 108. Furthermore, intermediate transfer belt cleaning devices 112 and 113 are disposed so as to be in contact with the intermediate transfer belt 107 after transfer.

In the multicolor image forming apparatus 100 having the above configuration, the image holder 101a rotates in the direction of the arrow C, and the surface thereof is charged by the charging device 102a. Then, an electrostatic charge image of a first color is formed by the exposure device 114a such as laser light. By the developing device 103a accommodating a toner corresponding to the color, the formed electrostatic charge image is developed (visualized) with a developer containing a toner, and a toner image is formed. The developing devices 103a to 103d each accommodate toners (for example, yellow, magenta, cyan, and black) corresponding to the electrostatic charge images of the respective colors.

The toner image formed on the image holder 101a is electrostatically transferred (primary transfer) onto the intermediate transfer belt 107 by the primary transfer roll 105a when passing through the primary transfer portion. Subsequently, toner images of a second color, a third color, and a fourth color are primarily transferred by the primary transfer rolls 105b to 105d onto the intermediate transfer belt 107 holding the toner image of the first color so as to be sequentially superimposed. Finally, a multicolor multi-toner image is obtained.

The multi-toner image formed on the intermediate transfer belt 107 is electrostatically batch-transferred to the recording medium 115 when passing through the secondary transfer portion. The recording medium 115 to which the toner image is transferred is transported to the fixing device 110 and fixed by heating and pressurization, heating, or pressurization, and then discharged to the outside of the apparatus.

The residual toners are removed from the image holders 101a to 101d after the primary transfer by the image holder cleaning devices 104a to 104d. Meanwhile, from the intermediate transfer belt 107 after the secondary transfer, the residual toners are removed by the intermediate transfer belt cleaning devices 112 and 113 to provide the intermediate transfer belt for a next image forming process.

### Image Holder

As the image holders 101a to 101d, known electrophotographic photoreceptors are widely applied. As the electrophotographic photoreceptor, an inorganic photoreceptor whose photosensitive layer is made of an inorganic material, an organic photoreceptor whose photosensitive layer is made of an organic material, or the like is used. In a case of the organic photoreceptor, a function separated organic photoreceptor in which a charge generation layer which generates a charge by exposure and a charge transport layer which transports the charge are laminated, or a monolayer organic photoreceptor which has a function of generating a charge and a function of transporting the charge is used. In addition, in a case of the inorganic photoreceptor, a photoreceptor having a photosensitive layer made of amorphous silicon is used.

In addition, the shape of the image holder is not particularly limited, and a known shape such as a cylindrical drum shape, a sheet shape, or a plate shape is adopted.

### Charging Device

The charging devices 102a to 102d are not particularly limited, and for example, a known charger such as a contact type charger using a conductive (here, the term “conductive” in the charging device means, for example, a volume resistivity of less than 10⁷ Ω·cm) or semiconductive (here, the term “semiconductive” in the charging device means, for example, a volume resistivity of 10⁷ Ω·cm or more and 10¹³ Ω·cm or less) roller, brush, film, or rubber blade, or a scorotron charger or a corotron charger using corona discharge is widely applied. Among these, for example, the contact type charger is desirable.

The charging devices 102a to 102d normally apply a DC current to the image holders 101a to 101d, but may further superimpose an AC current thereon and apply the resulting current.

### Exposure Device

The exposure devices 114a to 114d are not particularly limited, and for example, a known exposure device such as an optical system device capable of exposing a prescribed image on the surfaces of the image holders 101a to 101d by a light source such as semiconductor laser light, light emitting diode (LED) light, or liquid crystal shutter light or via a polygonal mirror from such light source is widely applied.

### Developing Device

The developing devices 103a to 103d are selected according to the purpose. Examples thereof include a known developing unit which performs developing in a contact or non-contact manner using a brush, a roller, or the like with a one-component developer or a two-component developer.

### Primary Transfer Roll

Each of the primary transfer rolls 105a to 105d may be either a single layer or a multilayer. For example, in a case of a single layer structure, the primary transfer roll is configured of a roll in which an appropriate amount of conductive particles such as carbon black is blended with foamed or non-foamed silicone rubber, urethane rubber, EPDM, or the like.

### Image Holder Cleaning Device

The image holder cleaning devices 104a to 104d are provided to remove the residual toner adhering to the surfaces of the image holders 101a to 101d after the primary transfer step, and a cleaning blade, brush cleaning, roll cleaning, or the like is used. Among these, for example, the cleaning blade is desirably used. In addition, examples of the material of the cleaning blade include urethane rubber, neoprene rubber, and silicone rubber.

### Secondary Transfer Roll

The layer structure of the secondary transfer roll 109 is not particularly limited. For example, in a case of a three-layer structure, the secondary transfer roll is configured of a core layer, an intermediate layer, and a coating layer covering a surface thereof. The core layer is configured of a foam of silicone rubber, urethane rubber, or EPDM in which conductive particles are dispersed, and the intermediate layer is configured of a non-foam of the silicone rubber, urethane rubber, or EPDM. Examples of the material of the coating layer include a tetrafluoroethylene-hexafluoropropylene copolymer and a perfluoroalkoxy resin. The volume resistivity of the secondary transfer roll 109 is, for example, desirably equal to or less than 10⁷ Ω·cm. In addition, a two-layer structure excluding the intermediate layer may be adopted.

### Counter Roll

The counter roll 108 forms a counter electrode of the secondary transfer roll 109. The layer structure of the counter roll 108 may be either a single layer structure or a multilayer structure. For example, in a case of a single layer structure, the counter roll is configured of a roll in which an appropriate amount of conductive particles such as carbon black is blended with silicone rubber, urethane rubber, EPDM, or the like. In a case of a two-layer structure, the counter roll is configured of a roll in which an outer peripheral surface of an elastic layer made of the above-described rubber material is covered with a high resistance layer.

A voltage of 1 kV or more and 6 kV or less is usually applied to the cores of the counter roll 108 and the secondary transfer roll 109. The voltage may be applied to an electrode member with good electrical conductivity, which is in contact with the counter roll 108, and the secondary transfer roll 109, instead of the voltage application to the core of the counter roll 108. Examples of the electrode member include a metal roll, a conductive rubber roll, a conductive brush, a metal plate, and a conductive resin plate.

### Fixing Device

As the fixing device 110, for example, a known fixer such as a heat roller fixer, a pressure roller fixer, or a flash fixer is widely used.

### Intermediate Transfer Belt Cleaning Device

As the intermediate transfer belt cleaning devices 112 and 113, a cleaning blade, brush cleaning, roll cleaning, or the like is used. From these, for example, the cleaning blade is desirably used. In addition, examples of the material of the cleaning blade include urethane rubber, neoprene rubber, and silicone rubber.

Next, an image forming apparatus using the endless belt according to the present exemplary embodiment as a recording medium transport body (paper transport belt) will be described.

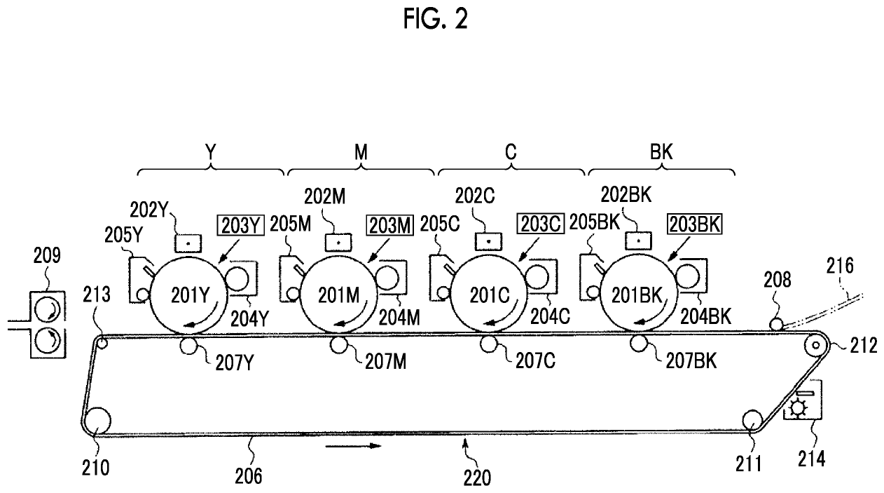

FIG. 2 is a schematic configuration diagram showing another example of the image forming apparatus according to the present exemplary embodiment. The image forming apparatus shown in FIG. 2 is an image forming apparatus in which the endless belt according to the present exemplary embodiment is applied to a recording medium transport body (paper transport belt).

In the image forming apparatus shown in FIG. 2, units Y, M, C, and BK are provided with photoreceptor drums (image holders) 201Y, 201M, 201C, and 201BK, respectively, which rotate in the clockwise direction of the arrow. Around the photoreceptor drums 201Y, 201M, 201C, and 201BK, chargers 202Y, 202M, 202C, and 202BK, exposure units 203Y, 203M, 203C, and 203BK, color developing devices (yellow developing device 204Y, magenta developing device 204M, cyan developing device 204C, and black developing device 204BK), and photoreceptor drum cleaning members 205Y, 205M, 205C, and 205BK are respectively disposed.

The four units Y, M, C, and BK are disposed in parallel with a paper transport belt 206 in the order of the units BK, C, M, and Y. However, the order is appropriately set according to the image forming method so that the units are arranged in the order, such as the order of the units BK, Y, C, and M.

The paper transport belt 206 is supported while being applied with a tension from the inner surface side by belt support rolls 210, 211, 212, and 213, and forms an endless belt unit 220. The paper transport belt 206 is adapted to rotate in the counterclockwise direction of the arrow with the same peripheral speed as the photoreceptor drums 201Y, 201M, 201C, and 201BK, and is disposed so that a part thereof positioned between the belt support rolls 212 and 213 is in contact with the photoreceptor drums 201Y, 201M, 201C, and 201BK, respectively. The paper transport belt 206 is provided with a belt cleaning member 214.

Transfer rolls 207Y, 207M, 207C, and 207BK are disposed at positions on the inside of the paper transport belt 206 which face portions where the paper transport belt 206 and the photoreceptor drums 201Y, 201M, 201C, and 201BK are in contact with each other, respectively, and form transfer regions where a toner image is transferred to paper (transfer object) 216 via the paper transport belt 206 with the photoreceptor drums 201Y, 201M, 201C, and 201BK. As shown in FIG. 2, the transfer rolls 207Y, 207M, 207C, and 207BK may be disposed directly below the photoreceptor drums 201Y, 201M, 201C, and 201BK, or disposed at positions deviated from the above positions, respectively.

A fixing device 209 is disposed so that the paper is transported thereto after passing through the respective transfer regions of the paper transport belt 206 and the photoreceptor drums 201Y, 201M, 201C, and 201BK.

The paper 216 is transported to the paper transport belt 206 by a paper transport roll 208.

In the image forming apparatus shown in FIG. 2, in the unit BK, the photoreceptor drum 201BK is driven to rotate. In conjunction with this, the charger 202BK is driven to charge a surface of the photoreceptor drum 201BK to a target polarity and a target potential. The photoreceptor drum 201BK whose surface is charged is then exposed imagewise by the exposure unit 203BK, and an electrostatic charge image is formed on the surface thereof.

Subsequently, the electrostatic charge image is developed by the black developing device 204BK. Then, a toner image is formed on the surface of the photoreceptor drum 201BK. In this case, the developer may be a one-component developer or a two-component developer.

The toner image passes through the transfer region of the photoreceptor drum 201BK and the paper transport belt 206, and the paper 216 is electrostatically attracted to the paper transport belt 206 and transported to the transfer region, so that the image is sequentially transferred to the surface of the paper 216 by an electric field formed by a transfer bias applied from the transfer roll 207BK.

After that, the toner remaining on the photoreceptor drum 201BK is cleaned and removed by the photoreceptor drum cleaning member 205BK. Then, the photoreceptor drum 201BK is subjected to the next image transfer.

The above image transfer is also performed in the units C, M, and Y by the above-described method.

The paper 216 on which the toner image is transferred by the transfer rolls 207BK, 207C, 207M, and 207Y is further transported to the fixing device 209, and the fixing is performed.

Thus, a target image is formed on the paper.

Next, an image forming apparatus using the endless belt according to the present exemplary embodiment as a fixing belt (heating belt, pressure belt) will be described.

Examples of the image forming apparatus using the endless belt according to the present exemplary embodiment as a fixing belt (heating belt, pressure belt) include the same image forming apparatuses as the image forming apparatuses shown in FIGS. 1 and 2. In addition, in the image forming apparatuses shown in FIGS. 1 and 2, as the fixing device 110 or the fixing device 209, for example, a fixing device using an endless belt according to the present exemplary embodiment to be described later is applied.

Hereinafter, a fixing device in which the endless belt according to the present exemplary embodiment is applied as a fixing belt (heating belt, pressure belt) will be described.

### Fixing Device

The fixing device has various configurations, and for example, includes a first rotating body and a second rotating body disposed in contact with an outer surface of the first rotating body.

Hereinafter, a fixing device including a heating belt and a pressure roll will be described as first and second aspects of the fixing device.

The fixing device is not limited to the first and second aspects, and may be a fixing device including a heating roll or a heating belt and a pressure belt. In addition, the endless belt according to the present exemplary embodiment can be applied to both the heating belt and the pressure belt.

Further, the fixing device is not limited to the first and second aspects, and may be an electromagnetic induction heating type fixing device.

### First Aspect of Fixing Device

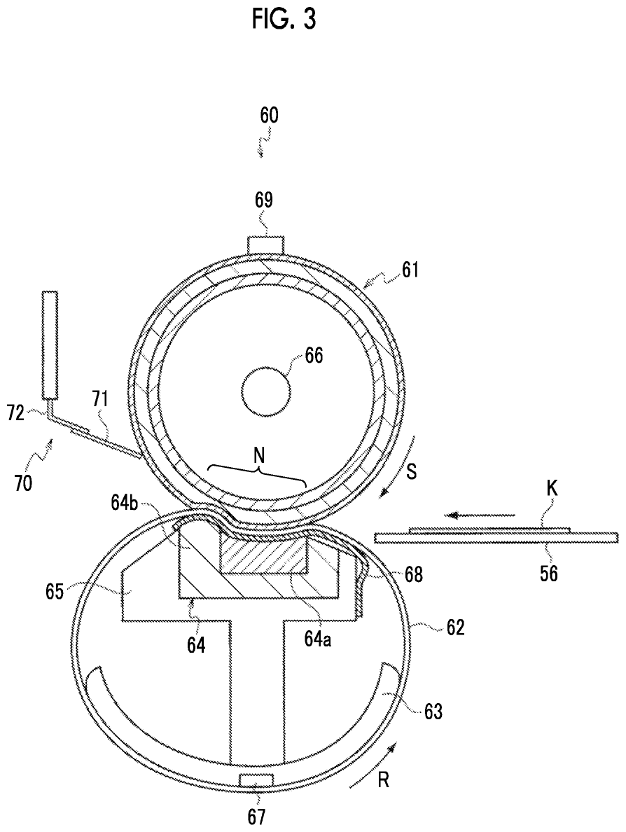

The fixing device according to the first aspect will be described. FIG. 3 is a schematic diagram showing an example of the fixing device according to the first aspect.

As shown in FIG. 3, a fixing device 60 according to the first aspect is configured to include, for example, a heating roll 61 (an example of a first rotating body) which is driven to rotate, a pressure belt 62 (an example of a second rotating body), and a pressing pad 64 (an example of a pressing member) which presses the heating roll 61 via the pressure belt 62.

Regarding the pressing pad 64, for example, the pressure belt 62 and the heating roll 61 may be relatively pressed. Therefore, the pressure belt 62 may be pressed against the heating roll 61, or the heating roll 61 may be pressed against the pressure belt 62.

A halogen lamp 66 (an example of heating means) is disposed inside the heating roll 61. The heating means is not limited to the halogen lamp, and other heat-generating members which generate heat may be used.

Meanwhile, for example, a temperature sensitive element 69 is disposed in contact with a surface of the heating roll 61. The lighting of the halogen lamp 66 is controlled based on a temperature measurement value by the temperature sensitive element 69, and a surface temperature of the heating roll 61 is maintained at a target set temperature (for example, 150° C.).

The pressure belt 62 is rotatably supported by, for example, the pressing pad 64 disposed therein and a belt traveling guide 63. In a sandwiching region N (nip portion), the pressure belt is disposed to be pressed against the heating roll 61 by the pressing pad 64.

The pressing pad 64 is, for example, disposed in a state of being pressed against the heating roll 61 via the pressure belt 62 inside the pressure belt 62, and forms a sandwiching region N with the heating roll 61.

In the pressing pad 64, for example, a front sandwiching member 64a for securing a wide sandwiching region N is disposed on the inlet side of the sandwiching region N, and a peeling sandwiching member 64b for giving distortion to the heating roll 61 is disposed on the outlet side of the sandwiching region N.

In order to reduce sliding resistance between an inner peripheral surface of the pressure belt 62 and the pressing pad 64, for example, a sheet-like sliding member 68 is provided on a surface of the front sandwiching member 64a and the peeling sandwiching member 64b in contact with the pressure belt 62. The pressing pad 64 and the sliding member 68 are held by a metal holding member 65.

The sliding member 68 is provided, for example, so that a sliding surface thereof is in contact with the inner peripheral surface of the pressure belt 62, and is involved in holding and supplying an oil existing between the sliding member 68 and the pressure belt 62.

For example, the belt traveling guide 63 is attached to the holding member 65, and the pressure belt 62 is configured to rotate.

The heating roll 61 rotates, for example, in the direction of the arrow S by a drive motor (not shown), and following the above rotation, the pressure belt 62 rotates in the direction of the arrow R opposite to the rotation direction of the heating roll 61. That is, for example, the heating roll 61 rotates clockwise in FIG. 3, while the pressure belt 62 rotates counterclockwise.

Then, paper K (an example of a recording medium) having an unfixed toner image is guided by, for example, a fixing inlet guide 56 and transported to the sandwiching region N. In a case where the paper K passes through the sandwiching region N, the toner image on the paper K is fixed by the pressure and heat acting on the sandwiching region N.

In the fixing device 60 according to the first aspect, for example, a concave front sandwiching member 64a following an outer peripheral surface of the heating roll 61 secures a wider sandwiching region N as compared with a configuration without the front sandwiching member 64a.

Further, the fixing device 60 according to the first aspect has, for example, a configuration in which by disposing the peeling sandwiching member 64b so as to protrude from the outer peripheral surface of the heating roll 61, the distortion of the heating roll 61 becomes locally large in the outlet region of the sandwiching region N.

In a case where the peeling sandwiching member 64b is disposed as above, for example, the paper K after fixing passes through the distortion formed locally large when passing through the peeling sandwiching region, and thus the paper K is easy to be peeled off from the heating roll 61.

As an auxiliary means for peeling, for example, a peeling member 70 is disposed on the downstream side of the sandwiching region N of the heating roll 61. The peeling member 70 is, for example, held by a holding member 72 in a state where a peeling claw 71 is close to the heating roll 61 in a direction facing the rotation direction of the heating roll 61 (counter direction).

### Second Aspect of Fixing Device

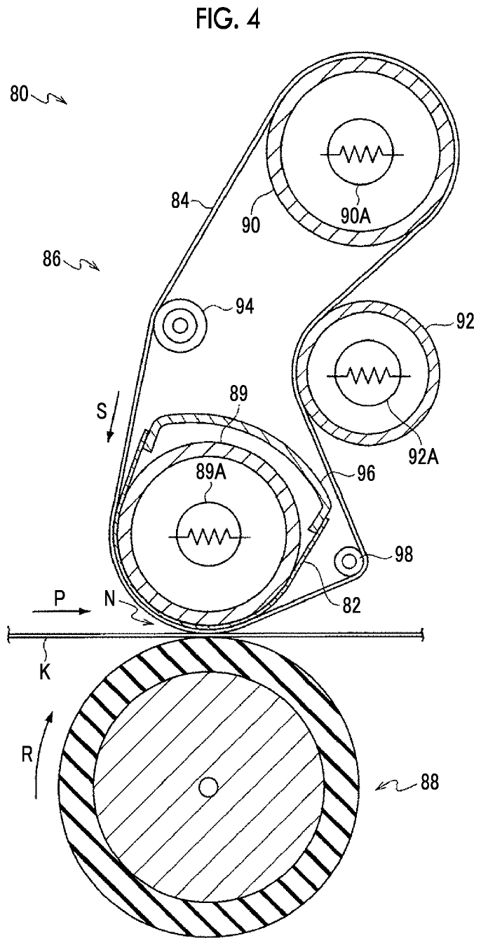

The fixing device according to the second aspect will be described. FIG. 4 is a schematic diagram showing an example of the fixing device according to the second aspect.

As shown in FIG. 4, a fixing device 80 according to the second aspect is configured to include, for example, a fixing belt module 86 including a heating belt 84 (an example of a first rotating body) and a pressure roll 88 (an example of a second rotating body) disposed to be pressed against the heating belt 84 (fixing belt module 86). For example, a sandwiching region N (nip portion) where the heating belt 84 (fixing belt module 86) and the pressure roll 88 are in contact with each other is formed. In the sandwiching region N, paper K (an example of a recording medium) is pressed and heated, and the toner image is fixed.

The fixing belt module 86 includes, for example, an endless heating belt 84, a heating pressing roll 89 around which the heating belt 84 is wound on the side of the pressure roll 88, and which is rotationally driven by the rotational force of a motor (not shown) and presses the heating belt 84 from an inner peripheral surface thereof toward the pressure roll 88, and a support roll 90 which supports the heating belt 84 from the inside at a position different from the heating pressing roll 89.

The fixing belt module 86 is provided with, for example, a support roll 92 which is disposed outside the heating belt 84 and defines a circulating path thereof, a posture correction roll 94 which corrects the posture of the heating belt 84 from the heating pressing roll 89 to the support roll 90, and a support roll 98 which applies a tension to the heating belt 84 from the inner peripheral surface on the downstream side of the sandwiching region N which is a region where the heating belt 84 (fixing belt module 86) and the pressure roll 88 are in contact with each other.

The fixing belt module 86 is provided, for example, so that a sheet-like sliding member 82 is interposed between the heating belt 84 and the heating pressing roll 89.

The sliding member 82 is provided, for example, so that a sliding surface thereof is in contact with an inner peripheral surface of the heating belt 84, and is involved in holding and supplying an oil existing between the sliding member 82 and the heating belt 84.

Here, the sliding member 82 is provided, for example, in a state where both ends thereof are supported by a support member 96.

For example, a halogen heater 89A (an example of a heating means) is provided inside the heating pressing roll 89.

The support roll 90 is, for example, a cylindrical roll made of aluminum, and a halogen heater 90A (an example of a heating means) is disposed therein, so that the heating belt 84 is heated from the inner peripheral surface side.

At both ends of the support roll 90, for example, spring members (not shown) pressing the heating belt 84 outward are disposed.

The support roll 92 is, for example, a cylindrical roll made of aluminum, and a release layer consisting of a fluororesin having a thickness of 20 μm is formed on a surface of the support roll 92.

The release layer of the support roll 92 is formed, for example, to prevent a toner or paper dust from the outer peripheral surface of the heating belt 84 from accumulating on the support roll 92.

For example, a halogen heater 92A (an example of a heating source) is disposed inside the support roll 92 so that the heating belt 84 is heated from the outer peripheral surface side.

That is, for example, the heating pressing roll 89, the support roll 90, and the support roll 92 are configured to heat the heating belt 84.

The posture correction roll 94 is, for example, a columnar roll made of aluminum, and an end position measurement mechanism (not shown) for measuring the end position of the heating belt 84 is disposed in the vicinity of the posture correction roll 94.

The posture correction roll 94 is provided with, for example, an axial displacement mechanism (not shown) which displaces a contact position of the heating belt 84 in an axial direction according to the measurement result of the end position measurement mechanism, and is configured to control meandering of the heating belt 84.

Meanwhile, the pressure roll 88 is, for example, rotatably supported, and the heating belt 84 is provided to be being pressed against a portion wound around the heating pressing roll 89 by an urging means such as a spring (not shown). As a result, as the heating belt 84 (heating pressing roll 89) of the fixing belt module 86 moves rotationally in the direction of the arrow S, the pressure roll 88 follows the heating belt 84 (heating pressing roll 89) and moves rotationally in the direction of the arrow R.

Then, in a case where the paper K having an unfixed toner image (not shown) is transported in the direction of the arrow P and guided to the sandwiching region N of the fixing device 80, the image is fixed by the pressure and heat acting on the sandwiching region N.

In the fixing device 80 according to the second aspect, a form in which the halogen heater (halogen lamp) is applied as an example of the heating source has been described, but the present invention is not limited thereto. A radiation lamp heating element (a heat generator generating radiation (such as infrared rays)) and a resistance heat generator (a heat generator generating Joule heat by passing an electric current through a resistor: for example, a ceramic substrate formed with a film having resistance and fired) other than the halogen heater may be applied.

### Endless Belt Unit

Examples of the endless belt unit according to the present exemplary embodiment include a unit including the endless belt according to the present exemplary embodiment and a plurality of rolls over which the endless belt is hung in a state of being applied with a tension.

The endless belt unit according to the present exemplary embodiment includes, for example, a cylindrical member and a plurality of rolls over which the cylindrical member is hung in a state of being applied with a tension as in the cases of the endless belt unit 107b shown in FIG. 1 and the endless belt unit 220 shown in FIG. 2.

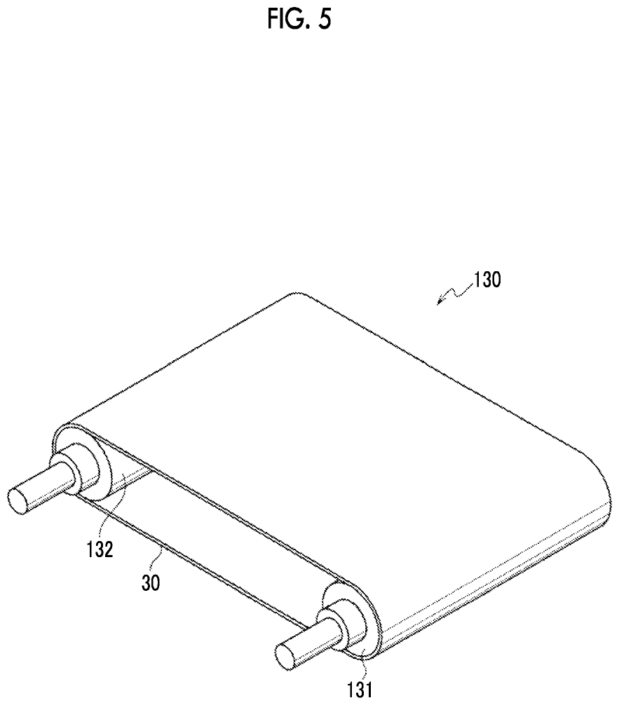

For example, as an example of the endless belt unit according to the present exemplary embodiment, an endless belt unit shown in FIG. 5 may be used.

FIG. 5 is a schematic perspective view showing the endless belt unit according to the present exemplary embodiment.

As shown in FIG. 5, an endless belt unit 130 according to the present exemplary embodiment includes an endless belt 30 according to the present exemplary embodiment. For example, the endless belt 30 is hung in a state of being applied with a tension by a drive roll 131 and a driven roll 132 disposed to face each other.

Here, in the endless belt unit 130 according to the present exemplary embodiment, in a case where the endless belt 30 is applied as an intermediate transfer body, a roll for primarily transferring a toner image on a surface of a photoreceptor (image holder) onto the endless belt 30 and a roll for further secondarily transferring the toner image transferred onto the endless belt 30 to a recording medium may be disposed as a roll supporting the endless belt 30.

The number of rolls supporting the endless belt 30 is not limited, and may be disposed according to the use mode. The endless belt unit 130 having the above configuration is used by being incorporated in the apparatus, and rotates in a state where the endless belt 30 is also supported as the drive roll 131 and the driven roll 132 rotate.

### EXAMPLES

Examples will be described below, but the present invention is not limited to these examples.

### Example 1

### Preparation of Polyimide Precursor Composition

200 g of tetramethylurea, which is a urea-based solvent, is added as a solvent to a flask attached with a stirrer, a thermometer, and a dripping funnel. 20.20 g of p-phenylenediamine is added thereto as a diamine compound, and the mixture is stirred at 20° C. for 10 minutes. 21.38 g of 3,3′,4,4′-biphenyl tetracarboxylic acid dianhydride as an aromatic tetracarboxylic acid dianhydride is added to the solution, and while the reaction temperature is maintained at 40° C., the mixture is stirred for 24 hours and dissolved to cause a reaction. Thus, a polyimide precursor composition containing a polyimide precursor is obtained.

### Coating Film Forming Step and Drying Step

The prepared polyimide precursor composition is applied to an outer surface of a cylindrical mold (base material) made of aluminum, and dried by rotation at 150° C. for 30 minutes.

### Firing Step

Next, the mold is heated in an oven at 300° C. for 1 hour while being rotated at 20 rpm, and then taken out from the oven.

### Removing Step

A molded body of the polyimide resin formed on the outer peripheral surface of the mold is removed from the mold to obtain an endless belt having a resin layer having a thickness of 0.08 mm.

### Examples 2 to 21 and Comparative Examples 1 to 5

Endless belts are obtained in the same manner as in Example 1, except that the kind of the solvent in the section of Preparation of Polyimide Precursor Composition and the temperature of the oven and the heating time in the section of Firing Step are changed as described in Table 1.

### Examples 22 to 27

Endless belts are obtained in the same manner as in Example 4, except that the kind of the diamine compound in the section of Preparation of Polyimide Precursor Composition is changed as described in Table 2.

### Evaluation

The tensile breaking strength of the endless belt obtained in each example according to the procedure described above and the number of times of folding endurance according to a MIT test are measured, and the results are shown in Table 1. The letters A to D in the column of the number of times of folding endurance according to the MIT test are recorded according to the following criteria.

### Criteria

The percentage (%) of an actual measurement value when a target value (300,000) of the number of times of folding endurance according to a MIT test is 100 [(actual measurement value of number of times of folding endurance according to MIT test÷target value of number of times of folding endurance according to MIT test)×100] is calculated, and based on the calculated value, any one of A to D is recorded in Table 1 according to the following criteria.
AA: 230%≤percentage of actual measurement value
A: 200%≤percentage of actual measurement value<230%
B: 120%≤percentage of actual measurement value<200%
C: 100%≤percentage of actual measurement value<120%
D: percentage of actual measurement value<100%

The number of times of folding endurance according to the MIT test is the number until a strip-like test piece obtained from the endless belt is broken by being repeatedly bent according to the procedure described above. The breakage is caused since cracking occurs at a bent portion. Accordingly, a larger value of the number of times of folding endurance according to the MIT test indicates an endless belt in which the occurrence of cracking at a bent portion is further suppressed even in a case where the endless belt is repeatedly bent.

TABLE 1

| | Preparation of Polyimide | | | | | | | | |
|---|---|---|---|---|---|---|---|---|---|
| | Precursor Composition | | | | | | Evaluation | | |
| | | | Boiling | Firing Step | | Resin Layer | Tensile | Number of Folds | |
| | | | Point of | Temperature | Heating | Amount of | Breaking | (number | A |
| | | | Solvent | of Oven | Time | Solvent | Strength | (unit: | to |
| | Solvent Kind | | (° C.) | (° C.) | (hour) | (ppm) | (N/mm²) | 10000)) | D |
| Example 1 | Urea | Tetramethylurea | 177 | 300 | 1 | 2500 | 320 | 40 | B |
| Example 2 | Urea | 1,3-dimethyl-2-imidazolidinone | 220 | 300 | 1 | 5000 | 330 | 45 | B |
| Example 3 | Urea | N,N-dimethylpropyleneurea | 246 | 320 | 1 | 5000 | 330 | 45 | B |
| Example 4 | Alkoxyamide | 3-methoxy-N,N- | 215 | 295 | 1 | 6000 | 425 | 65 | A |
| | | dimethylpropanamide | | | | | | | |
| Example 5 | Alkoxyamide | 3-n-butoxy-N,N- | 252 | 320 | 1 | 6000 | 410 | 60 | A |
| | | dimethylpropanamide | | | | | | | |
| Example 6 | Esteramide | 5-dimethylamino-2-methyl- | 274 | 320 | 1 | 7000 | 425 | 65 | A |
| | | 5-oxo-methyl pentanoate | | | | | | | |
| Example 7 | Urea | Tetraethylurea | 214 | 300 | 0.6 | 9900 | 280 | 32 | C |
| Example 8 | Urea | 1,3-dimethyl-2-imidazolidinone | 220 | 300 | 0.7 | 9900 | 300 | 35 | C |
| Comparative | Urea | Tetraethylurea | 177 | 320 | 1 | 2000 | 250 | 25 | D |
| Example 1 | | | | | | | | | |
| Comparative | Urea | Tetraethylurea | 177 | 280 | 0.7 | 10100 | 250 | 25 | D |
| Example 2 | | | | | | | | | |
| Comparative | Alkoxyamide | 3-methoxy-N,N- | 215 | 320 | 1 | 2000 | 260 | 25 | D |
| Example 3 | | dimethylpropanamide | | | | | | | |
| Comparative | Alkoxyamide | 3-methoxy-N,N- | 215 | 275 | 0.7 | 10100 | 260 | 25 | D |
| Example 4 | | dimethylpropanamide | | | | | | | |
| Example 9 | Urea | Tetraethylurea | 177 | 280 | 0.8 | 9900 | 300 | 33 | C |
| Example 10 | Alkoxyamide | N,N-dimethylacetamide | 165 | 280 | 0.8 | 6000 | 330 | 45 | B |
| Example 11 | Urea | Tetraethylurea | 177 | 310 | 1 | 2300 | 300 | 35 | C |
| Example 12 | Urea | Tetraethylurea | 177 | 280 | 1 | 8400 | 320 | 40 | B |
| Example 13 | Esteramide | 5-dimethylamino-2-methyl- | 274 | 320 | 2 | 2200 | 300 | 35 | C |
| | | 5-oxo-methyl pentanoate | | | | | | | |
| Example 14 | Esteramide | 5-dimethylamino-2-methyl- | 274 | 320 | 1.7 | 2700 | 330 | 45 | B |
| | | 5-oxo-methyl pentanoate | | | | | | | |
| Example 15 | Esteramide | 5-dimethylamino-2-methyl- | 274 | 320 | 0.8 | 8600 | 320 | 40 | B |
| | | 5-oxo-methyl pentanoate | | | | | | | |
| Example 16 | Esteramide | 5-dimethylamino-2-methyl- | 274 | 320 | 0.7 | 9500 | 300 | 33 | C |
| | | 5-oxo-methyl pentanoate | | | | | | | |
| Example 17 | Alkoxyamide | 3-methoxy-N,N- | 215 | 320 | 0.8 | 2250 | 280 | 32 | C |
| | | dimethylpropanamide | | | | | | | |
| Example 18 | Alkoxyamide | 3-methoxy-N,N- | 215 | 320 | 0.7 | 2800 | 325 | 43 | B |
| | | dimethylpropanamide | | | | | | | |
| Example 19 | Alkoxyamide | 3-methoxy-N,N- | 215 | 295 | 0.8 | 8300 | 330 | 45 | B |
| | | dimethylpropanamide | | | | | | | |
| Example 20 | Alkoxyamide | 3-methoxy-N,N- | 215 | 295 | 0.7 | 9600 | 300 | 33 | C |
| | | dimethylpropanamide | | | | | | | |
| Comparative | Alkoxyamide | N,N-dimethylacetamide | 165 | 310 | 1 | 2000 | 260 | 25 | D |
| Example 5 | | | | | | | | | |
| Example 21 | Alkoxyamide | N,N-dimethylacetamide | 165 | 310 | 0.8 | 2300 | 280 | 33 | C |

TABLE 2

| | Preparation of Polyimide | | | | | Firing Step | | | Evaluation | | |
|---|---|---|---|---|---|---|---|---|---|---|---|
| | Precursor Composition | | | | | Temper- | | Resin | | Number | |
| | | | | | Boiling | ature | | Layer | Tensile | of Folds | |
| | | | | | Point of | of | Heating | Amount of | Breaking | (number | A |
| | | | Diamine Compound | | Solvent | Oven | Time | Solvent | Strength | (unit: | to |
| | Solvent Kind | | Kind (Proportion) | | (° C.) | (° C.) | (hour) | (ppm) | (N/mm²) | 10000)) | D |
| Example | Alkox- | 3-methoxy-N,N- | p- | 4,4′- | 215 | 295 | 1 | 6000 | 420 | 67 | A |
| 22 | yamide | dimethyl- | phenylenediamine | diaminodiphenyl | | | | | | | |
| | | propanamide | (99.8 mol %) | ether | | | | | | | |
| | | | | (0.2 mol %) | | | | | | | |
| Example | Alkox- | 3-methoxy-N,N- | p- | 4,4′- | 215 | 295 | 1 | 6000 | 410 | 70 | AA |
| 23 | yamide | dimethyl- | phenylenediamine | diaminodiphenyl | | | | | | | |
| | | propanamide | (99.7 mol %) | ether | | | | | | | |
| | | | | (0.3 mol %) | | | | | | | |
| Example | Alkox- | 3-methoxy-N,N- | p- | 4,4′- | 215 | 295 | 1 | 6000 | 405 | 75 | AA |
| 24 | yamide | dimethyl- | phenylenediamine | diaminodiphenyl | | | | | | | |
| | | propanamide | (90 mol %) | ether | | | | | | | |
| | | | | (10 mol %) | | | | | | | |
| Example | Alkox- | 3-methoxy-N,N- | m- | 3,4′- | 215 | 295 | 1 | 6000 | 400 | 72 | AA |
| 25 | yamide | dimethyl- | phenylenediamine | diaminodiphenyl | | | | | | | |
| | | propanamide | (90 mol %) | ether | | | | | | | |
| | | | | (10 mol %) | | | | | | | |
| Example | Alkox- | 3-methoxy-N,N- | p- | 4,4′- | 215 | 295 | 1 | 6000 | 400 | 70 | AA |
| 26 | yamide | dimethyl- | phenylenediamine | diaminodiphenyl | | | | | | | |
| | | propanamide | (80 mol %) | ether | | | | | | | |
| | | | | (20 mol %) | | | | | | | |
| Example | Alkox- | 3-methoxy-N,N- | p- | 4,4′- | 215 | 295 | 1 | 6000 | 395 | 67 | A |
| 27 | yamide | dimethyl- | phenylenediamine | diaminodiphenyl | | | | | | | |
| | | propanamide | (75 mol %) | ether | | | | | | | |
| | | | | (25 mol %) | | | | | | | |

The abbreviations in Tables 1 and 2 are as follows.

### Solvent Kind

Urea: Urea-based solvent
Alkoxyamide: Alkoxy group-containing amide-based solvent
Esteramide: Ester group-containing amide-based solvent

From the above results, it is found that the endless belts of the present example are an endless belt in which the occurrence of cracking at a bent portion is suppressed even in a case where the endless belt is repeatedly bent.

In accordance with the manufacturing conditions of the endless belt of each example, a resin film is prepared and the tensile breaking strength and the number of times of folding endurance according to the MIT test are measured, and the same results are obtained as in the endless belt of each example. As a result, it is found that the occurrence of cracking at a bent portion is also suppressed in the resin film even in a case where the resin film is repeatedly bent.

### Resin Film

### Coating Film Forming Step and Drying Step

The prepared polyimide precursor composition is applied onto a glass plate (base material) using a bar coater, and dried at 150° C. for 30 minutes.

### Firing Step

Then, the glass plate is heated in an oven, and then taken out of the oven.

### Removing Step

The polyimide resin film formed on the glass plate is peeled off from the glass plate to obtain a resin film having a thickness of 0.08 mm.
(((1)))

A resin film comprising:
a resin layer containing at least one solvent selected from the group consisting of a urea-based solvent, an alkoxy group-containing amide-based solvent, and an ester group-containing amide-based solvent,
wherein a content of the solvent is more than 2,200 ppm and equal to or less than 10,000 ppm with respect to the entire resin layer.
(((2)))

The resin film according to (((1))),
wherein the solvent is at least one selected from the group consisting of an alkoxy group-containing amide-based solvent and an ester group-containing amide-based solvent.
(((3)))

The resin film according to (((2))),
wherein the alkoxy group-containing amide-based solvent is at least one selected from the group consisting of 3-methoxy-N,N-dimethylpropanamide and 3-n-butoxy-N,N-dimethylpropanamide, and
the ester group-containing amide-based solvent is methyl 5-(dimethylamino)-2-methyl-5-oxopentanoate.
(((4)))

The resin film according to any one of (((1))) to (((3))),
wherein the solvent is 3-methoxy-N,N-dimethylpropanamide.
(((5)))

The resin film according to any one of (((1))) to (4))),
wherein the resin layer contains a polyimide resin having a structural unit derived from phenylenediamine and a structural unit derived from diaminodiphenyl ether, and
a content ratio of the structural unit derived from phenylenediamine to the structural unit derived from diaminodiphenyl ether (the structural unit derived from phenylenediamine/the structural unit derived from diaminodiphenyl ether) in the polyimide resin is, in mole ratio, equal to or more than 80/20 and equal to or less than 99.7/0.3.
(((6)))

The resin film according to any one of (((1))) to ((5))),
wherein the content of the solvent is equal to or more than 2,500 ppm and equal to or less than 9,000 ppm with respect to the entire resin layer.
(((7)))

The resin film according to (((6))),
wherein the content of the solvent is equal to or more than 6,000 ppm and equal to or less than 7,000 ppm with respect to the entire resin layer.
(((8)))

The resin film according to any one of (((1))) to (((7))),
wherein the solvent has a boiling point of 200° C. or higher and 280° C. or lower.
(((9)))

The resin film according to any one of (((1))) to (((8))),
wherein a number of times of folding endurance according to a MIT test using a clamp having a radius of curvature R of 2 mm is equal to or more than 300,000.
(((10)))

A resin film comprising:
a resin layer containing at least one solvent selected from the group consisting of a urea-based solvent, an alkoxy group-containing amide-based solvent, and an ester group-containing amide-based solvent,
wherein a tensile breaking strength is equal to or more than 270 N/mm².
(((11)))

An endless belt consisting of the resin film according to any one of (((1))) to (((10))).
(((12)))

An image forming apparatus comprising:
the endless belt according to (((11))).
(((13)))

An image forming apparatus comprising:
an image holder;
a charging device that charges a surface of the image holder;
an electrostatic charge image forming device that forms an electrostatic charge image on the charged surface of the image holder;
a developing device that develops the electrostatic charge image formed on the surface of the image holder with a developer containing a toner to form a toner image;
a transfer device that transfers the toner image to a recording medium; and
a fixing device that fixes the toner image to the recording medium,
wherein at least one selected from the group consisting of the transfer device and the fixing device has the endless belt according to (((11))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin film comprising:
a resin layer containing at least one solvent selected from the group consisting of a urea-based solvent, an alkoxy group-containing amide-based solvent, and an ester group-containing amide-based solvent,
wherein a content of the solvent is more than 2,200 ppm and equal to or less than 10,000 ppm with respect to the entire resin layer.

2. The resin film according to claim 1,
wherein the solvent is at least one selected from the group consisting of an alkoxy group-containing amide-based solvent and an ester group-containing amide-based solvent.

3. The resin film according to claim 2,
wherein the alkoxy group-containing amide-based solvent is at least one selected from the group consisting of 3-methoxy-N,N-dimethylpropanamide and 3-n-butoxy-N,N-dimethylpropanamide, and
the ester group-containing amide-based solvent is methyl 5-(dimethylamino)-2-methyl-5-oxopentanoate.

4. The resin film according to claim 1,
wherein the solvent is 3-methoxy-N,N-dimethylpropanamide.

5. The resin film according to claim 1,
wherein the resin layer contains a polyimide resin having a structural unit derived from phenylenediamine and a structural unit derived from diaminodiphenyl ether, and
a content ratio of the structural unit derived from phenylenediamine to the structural unit derived from diaminodiphenyl ether (the structural unit derived from phenylenediamine/the structural unit derived from diaminodiphenyl ether) in the polyimide resin is, in mole ratio, equal to or more than 80/20 and equal to or less than 99.7/0.3.

6. The resin film according to claim 1,
wherein the content of the solvent is equal to or more than 2,500 ppm and equal to or less than 9,000 ppm with respect to the entire resin layer.

7. The resin film according to claim 6,
wherein the content of the solvent is equal to or more than 6,000 ppm and equal to or less than 7,000 ppm with respect to the entire resin layer.

8. The resin film according to claim 1,
wherein the solvent has a boiling point of 200° C. or higher and 280° C. or lower.

9. The resin film according to claim 1,
wherein a number of times of folding endurance according to a MIT test using a clamp having a radius of curvature R of 2 mm is equal to or more than 300,000.

10. A resin film comprising:
a resin layer containing at least one solvent selected from the group consisting of a urea-based solvent, an alkoxy group-containing amide-based solvent, and an ester group-containing amide-based solvent,
wherein a tensile breaking strength is equal to or more than 270 N/mm².

11. An endless belt consisting of the resin film according to claim 1.

12. An endless belt consisting of the resin film according to claim 2.

13. An endless belt consisting of the resin film according to claim 3.

14. An endless belt consisting of the resin film according to claim 4.

15. An endless belt consisting of the resin film according to claim 5.

16. An endless belt consisting of the resin film according to claim 6.

17. An endless belt consisting of the resin film according to claim 7.

18. An endless belt consisting of the resin film according to claim 8.

19. An image forming apparatus comprising:
the endless belt according to claim 11.

20. An image forming apparatus comprising:
an image holder;
a charging device that charges a surface of the image holder;
an electrostatic charge image forming device that forms an electrostatic charge image on the charged surface of the image holder;
a developing device that develops the electrostatic charge image formed on the surface of the image holder with a developer containing a toner to form a toner image;
a transfer device that transfers the toner image to a recording medium; and
a fixing device that fixes the toner image to the recording medium,
wherein at least one selected from the group consisting of the transfer device and the fixing device has the endless belt according to claim 11.
